(19) United States
(12) Patent Application Publication
(10) Pub. No.: US 2026/0330804 A1
(43) Pub. Date: Oct. 22, 2026

(54) SYSTEM

(71) Applicant: SoftBank Group Corp., Tokyo (JP)

(72) Inventor: Hiroki YAMAMOTO, Tokyo (JP)

(73) Assignee: SoftBank Group Corp., Tokyo (JP)

(21) Appl. No.: 19/531,663

(22) Filed: Feb. 6, 2026

(30) Foreign Application Priority Data
Feb. 21, 2025 (JP) 2025-027057

(51) Int. Cl. G06V 10/74; G06N 3/084; G06T 11/60; G06V 10/44; G06V 10/774; G06V 10/82

(52) U.S. Cl. CPC G06V 10/761; G06N 3/084; G06T 11/60; G06V 10/454; G06V 10/774; G06V 10/82

(57) ABSTRACT

The system according to the embodiment comprises a collection unit, a learning unit, a matching unit, and a correction unit. The collection unit collects image data. The learning unit learns the image data collected by the collection unit. The matching unit performs image matching using an AI model learned by the learning unit. The correction unit corrects the position of an object recognized by the matching unit.

### CROSS-REFERENCE TO RELATED APPLICATION

The present application claims priority to and incorporates by reference the entire contents of Japanese Patent Application No. 2025-027057 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there is room for improvement because the accuracy of object selection by image matching is not sufficient.

### SUMMARY OF THE INVENTION

The system according to the embodiment comprises a collection unit, a learning unit, a matching unit, and a correction unit. The collection unit collects image data. The learning unit learns the image data collected by the collection unit. The matching unit performs image matching using an AI model learned by the learning unit. The correction unit corrects the position of an object recognized by the matching unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

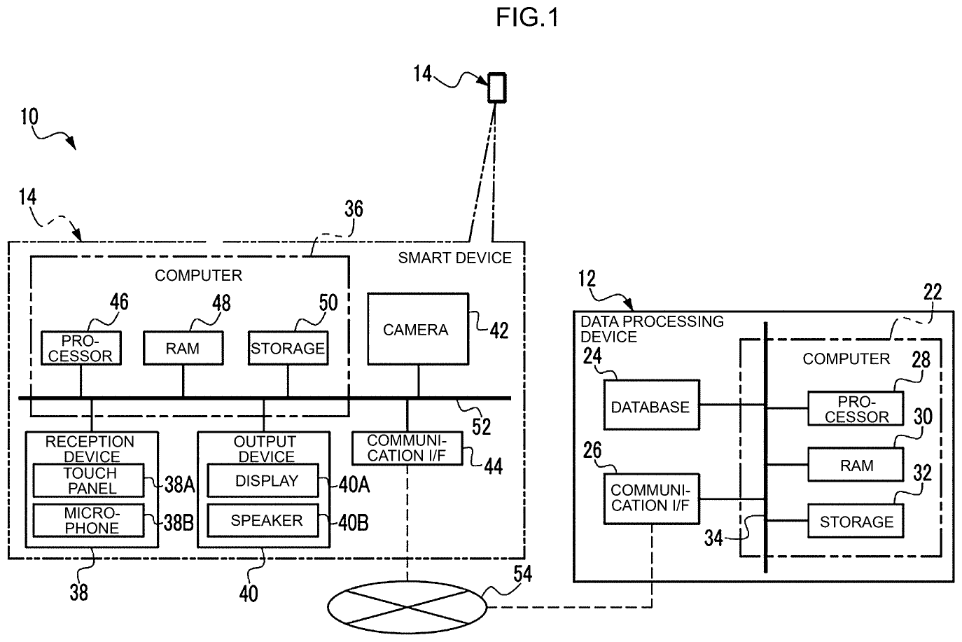

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

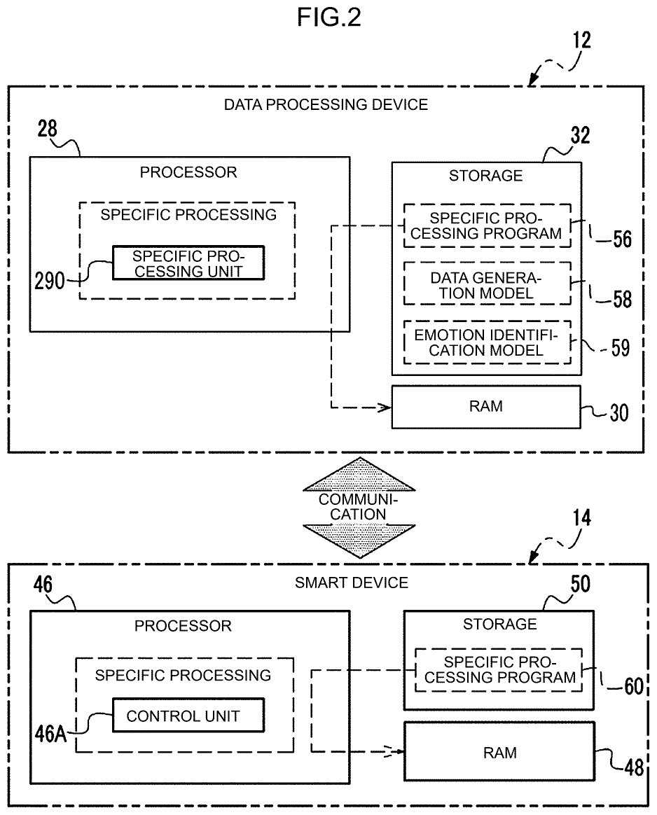

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The RPA scenario creation system according to the embodiment of the present invention is a system that utilizes AI for correction during object selection using image matching, thereby improving accuracy. This system collects image data of target objects and trains an AI model using the collected image data. Image matching is performed using the trained AI model, and the position of the recognized object is corrected. Through this mechanism, the accuracy of image matching is improved, and the execution of RPA scenarios becomes more stable and precise. For example, image data of target objects is collected, such as screenshots of buttons and icons at various angles and resolutions. Next, the collected image data is used to train the AI model. The AI model analyzes the image data and learns patterns for recognizing specific objects. Image matching is then performed using the trained AI model. The AI model recognizes objects on the screen and specifically identifies their positions. Finally, correction is performed based on the position of the object recognized by the AI model. For example, if the position of the object is slightly misaligned, the AI model performs correction to accurately identify the position. In this way, by utilizing AI, the accuracy of image matching can be improved, resulting in more stable and precise execution of RPA scenarios. Thus, the RPA scenario creation system can improve the accuracy of image matching and enable more stable and precise execution of RPA scenarios. Specifically, in the image data collection stage, the collection unit acquires screenshots of target objects such as buttons and icons at various angles (e.g., 0°, 30°, 60°, 90°) and resolutions (e.g., 720 p, 1080 p, 4K) to ensure diversity and comprehensiveness of the learning dataset. The system applies preprocessing such as noise removal (e.g., Gaussian filter), normalization (e.g., pixel value scaling to 0-1), and contrast correction to the collected image data in the preprocessing unit before inputting it to the learning unit. The learning unit uses deep learning models specialized for image recognition, such as convolutional neural networks (CNN) or Vision Transformers, to extract feature vectors (e.g., 512 dimensions) from image tensors (e.g., 3-channel RGB, 224×224 pixels) and outputs classification labels and bounding box coordinates (e.g., top-left x, y, width w, height h). During training, weights are optimized by backpropagation using cross-entropy loss and IoU (Intersection over Union) loss. The trained model, in the matching unit, calculates cosine similarity or Euclidean distance between feature vectors of input images and template images, and determines a match if the threshold (e.g., 0.85 or higher) is exceeded. Matching results include detected object positions (e.g., x, y, w, h in screen coordinates) and confidence scores (e.g., 0.92). The correction unit receives these output values and applies position correction algorithms (e.g., Kalman filter for time-series correction, local subpixel interpolation) while referring to past matching error history and screen layout information. Example outputs of the AI model include: input: 224×224 pixel button image→output: bounding box (x=120, y=80, w=40, h=20), confidence 0.95; or input: icon image of different resolutions→output: multiple candidate positions and scores (e.g., candidate 1: x=50, y=60, 0.88; candidate 2: x=52, y=62, 0.85). In subsequent processing, if the confidence is below the threshold, the correction unit instructs re-matching or additional data collection; if above the threshold, it passes accurate position information to the automatic execution module of the RPA scenario. As a technical effect, this system, unlike conventional simple template matching or manual position specification, achieves robust object recognition and correction resistant to environmental changes such as lighting variation, resolution differences, and screen layout changes by combining similarity calculation in high-dimensional feature space and time-series correction, thereby greatly improving the automation accuracy, stability, and reproducibility of RPA scenarios. Application fields include automatic operation of business applications, test automation, automation tools resistant to UI changes, image-based automatic control in manufacturing, and automatic labeling of medical images. These configurations and processing procedures not only automate human tasks but also contribute to the evolution and improvement of computer-based image recognition and correction technologies themselves.

The RPA scenario creation system according to the embodiment comprises a collection unit, a learning unit, a matching unit, and a correction unit. The collection unit collects image data of target objects. For example, the collection unit can collect screenshots of buttons and icons at various angles and resolutions. The collection unit can collect image data at various angles and resolutions, such as 30°, 60°, 720 p, and 1080 p. The learning unit analyzes the collected image data and learns patterns for recognizing specific objects. For example, the learning unit can learn image data using algorithms such as deep learning or support vector machines. The learning unit can learn specific patterns such as shape, color, and texture. The matching unit performs image matching using the AI model trained by the learning unit. For example, the matching unit can perform image matching using methods such as feature point matching or template matching. The matching unit can recognize objects on the screen and specifically identify their positions. The correction unit performs correction based on the position of the object recognized by the matching unit. For example, the correction unit can perform correction using methods such as position correction or color correction. Thus, the RPA scenario creation system according to the embodiment can improve the accuracy of image matching and enable more stable and precise execution of RPA scenarios. Some or all of the above-described processing in the correction unit may be performed using AI or without using AI. For example, the correction unit can perform correction using an AI model that performs correction based on the position of the recognized object. Specifically, the RPA scenario creation system ensures diversity and comprehensiveness of the learning dataset by having the collection unit acquire screenshots of target objects such as buttons and icons at various angles (e.g., 0°, 30°, 60°, 90°) and resolutions (e.g., 720 p, 1080 p, 4 K). The system applies preprocessing such as noise removal (e.g., Gaussian filter), normalization (e.g., pixel value scaling to 0-1), and contrast correction to the collected image data in the preprocessing unit before inputting it to the learning unit. The learning unit uses deep learning models specialized for image recognition, such as convolutional neural networks (CNN) or Vision Transformers, to extract feature vectors (e.g., 512 dimensions) from image tensors (e.g., 3-channel RGB, 224×224 pixels) and outputs classification labels and bounding box coordinates (e.g., top-left x, y, width w, height h). During training, weights are optimized by backpropagation using cross-entropy loss and IoU (Intersection over Union) loss. The trained model, in the matching unit, calculates cosine similarity or Euclidean distance between feature vectors of input images and template images, and determines a match if the threshold (e.g., 0.85 or higher) is exceeded. Matching results include detected object positions (e.g., x, y, w, h in screen coordinates) and confidence scores (e.g., 0.92). The correction unit receives these output values and applies position correction algorithms (e.g., Kalman filter for time-series correction, local subpixel interpolation) while referring to past matching error history and screen layout information. Example inputs and outputs of the AI model include: input: 224×224 pixel button image→output: bounding box (x=120, y=80, w=40, h=20), confidence 0.95; or input: icon image of different resolutions →output: multiple candidate positions and scores (e.g., candidate 1: x=50, y=60, 0.88; candidate 2: x=52, y=62, 0.85). In subsequent processing, if the confidence is below the threshold, the correction unit instructs re-matching or additional data collection; if above the threshold, it passes accurate position information to the automatic execution module of the RPA scenario. As a technical effect, this system, unlike conventional simple template matching or manual position specification, achieves robust object recognition and correction resistant to environmental changes such as lighting variation, resolution differences, and screen layout changes by combining similarity calculation in high-dimensional feature space and time-series correction, thereby greatly improving the automation accuracy, stability, and reproducibility of RPA scenarios. Application fields include automatic operation of business applications, test automation, automation tools resistant to UI changes, image-based automatic control in manufacturing, and automatic labeling of medical images. These configurations and processing procedures not only automate human tasks but also contribute to the evolution and improvement of computer-based image recognition and correction technologies themselves.

The preprocessing unit can perform preprocessing of learning data. The preprocessing unit can perform preprocessing such as noise removal and normalization. For example, the preprocessing unit removes noise from image data to improve data quality. In addition, the preprocessing unit can normalize image data to maintain data consistency. Thus, by performing preprocessing of learning data, the preprocessing unit can improve the accuracy of learning. Some or all of the above-described processing in the preprocessing unit may be performed using AI or without using AI. For example, the preprocessing unit can perform preprocessing using an AI model that performs noise removal and normalization. Specifically, the preprocessing unit applies spatial filtering techniques such as Gaussian filter or median filter to image data to reduce random noise and spike noise. Furthermore, the preprocessing unit uses algorithms such as histogram equalization or contrast-limited adaptive histogram equalization (CLAHE) to optimize image contrast. The preprocessing unit also performs normalization processing by scaling pixel values to the range of 0-1 and standardization processing using mean and standard deviation. When using an AI model, the preprocessing unit applies a convolutional neural network that estimates noise levels and performs automatic contrast correction, with image tensors (e.g., 3-channel RGB, 224×224 pixels) as input. Example outputs of the AI model include: input: noisy image→output: noise-removed image; input: low-contrast image→output: contrast-corrected image. The preprocessing unit calculates quality evaluation indices (e.g., PSNR, SSIM) and automatically excludes images below the threshold. In subsequent processing, the preprocessing unit records the list of excluded images and passes only high-quality images to the learning unit. As a technical effect, the preprocessing unit homogenizes the quality of image data and improves the convergence, accuracy, and generalization performance of learning algorithms. Application fields include medical image analysis, appearance inspection on manufacturing lines, and preprocessing of surveillance camera footage. These processes, unlike manual selection or correction by human visual inspection, realize automatic and consistent quality control by computers.

The hardware management unit can manage hardware used for learning. The hardware management unit can perform hardware management such as resource allocation and usage monitoring. For example, the hardware management unit optimally allocates resources of hardware used for learning. The hardware management unit can also monitor the usage status of hardware during learning in real time and perform efficient hardware management. Thus, by managing hardware used for learning, the hardware management unit can improve the efficiency of learning. Some or all of the above-described processing in the hardware management unit may be performed using AI or without using AI. For example, the hardware management unit can perform hardware management using an AI model that performs resource allocation and usage monitoring. Specifically, the hardware management unit monitors the usage status of various hardware resources such as parallel computing clusters using GPUs, CPU resources, memory capacity, and storage I/O bandwidth, and performs optimal resource allocation for each learning job. The hardware management unit uses a resource monitoring module to collect indicators such as GPU utilization (e.g., 80%), memory consumption (e.g., 16 GB/32 GB), and I/O wait time (e.g., 5 ms) in real time. When using an AI model, the hardware management unit inputs these resource usage status vectors (e.g., usage rate array for each device) and outputs bottleneck detection and load balancing plans. Example outputs of the AI model include: input: GPU utilization 80%, memory utilization 50%→output: assign new job to GPU2; input: I/O bandwidth congestion→output: schedule data transfer at night. In subsequent processing, the hardware management unit notifies the job scheduler of the allocation results to maximize the processing efficiency of the learning unit. As a technical effect, the hardware management unit achieves reduction of learning time, lower power consumption, and improved system throughput through dynamic optimization of resources. Application fields include large-scale deep learning environments, cloud-based AI services, and distributed learning platforms. These processes, unlike manual resource allocation and monitoring by humans, enable autonomous and optimal hardware operation by computers.

The collection unit can collect screenshots of buttons and icons at various angles and resolutions. The collection unit can collect image data at various angles and resolutions, such as 30°, 60°, 720 p, and 1080 p. For example, by collecting screenshots of buttons and icons at multiple angles and resolutions, the collection unit can improve the diversity of learning data. Thus, by collecting screenshots of buttons and icons at various angles and resolutions, the collection unit can improve the diversity of learning data. Some or all of the above-described processing in the collection unit may be performed using AI or without using AI. For example, the collection unit can perform collection using an AI model that collects image data at various angles and resolutions. Specifically, the collection unit automatically detects buttons and icons on the user interface and acquires images at specified angles (e.g., 0°, 30°, 60°, 90°) and resolutions (e.g., 720 p, 1080 p, 4 K) using a screen capture API. During image acquisition, the collection unit applies rotation matrices and resizing algorithms to generate images of the same object from diverse viewpoints and scales. When using an AI model, the collection unit inputs the entire screen image tensor (e.g., 1920×1080 pixels) to an object detection model (e.g., YOLO, Faster R-CNN) to identify the positions of buttons and icons, and performs cropping and transformation processing for each position. Example outputs of the AI model include: input: full screen capture→output: button 1 (x=100, y=200, w=40, h=20, 0°), button 2 (x=300, y=400, w=50, h=25, 30°). In subsequent processing, the collection unit stores the acquired images in a database together with metadata (angle, resolution, acquisition time) and provides them to the learning unit. As a technical effect, by increasing the diversity of image data, the collection unit enables the construction of AI models with improved generalizability and robustness, resistant to environmental changes such as lighting variation and UI changes. Application fields include UI automation, robotic process automation, and multi-view inspection in manufacturing. These processes, unlike manual capture or single-view collection by humans, realize comprehensive and automatic data collection by computers.

The learning unit can analyze the collected image data and learn specific patterns for recognizing particular objects. The learning unit can learn image data using algorithms such as deep learning or support vector machines. For example, the learning unit can learn specific patterns such as shape, color, and texture. Thus, by analyzing the collected image data and learning patterns for recognizing specific objects, the learning unit can improve the accuracy of the AI model. Some or all of the above-described processing in the learning unit may be performed using generative AI or without using generative AI. For example, the learning unit can input the collected image data to generative AI and have the generative AI learn patterns for recognizing specific objects. Specifically, the learning unit selects different architectures such as convolutional neural networks (CNN), Vision Transformers, or support vector machines (SVM), and inputs image tensors (e.g., 3-channel RGB, 224×224 pixels) to extract low-dimensional features such as edges, corners, color distribution, and texture patterns in the feature extraction layer. The learning unit generates high-dimensional feature vectors (e.g., 512 dimensions) in intermediate layers and outputs object class labels and bounding box coordinates in fully connected or classification layers. During training, weights are optimized by backpropagation using cross-entropy loss and IoU loss. When using generative AI, the learning unit inputs image data together with text descriptions or metadata and integrates visual and linguistic features through multimodal learning. Example inputs and outputs of the AI model include: input: 224×224 pixel button image→output: class label “button”, bounding box (x=120, y=80, w=40, h=20), confidence 0.95; or input: icon images of different resolutions and angles →output: multiple candidate positions and scores (e.g., candidate 1: x=50, y=60, 0.88; candidate 2: x=52, y=62, 0.85). In subsequent processing, the learning unit deploys the trained model to the matching unit for use in image recognition during inference. As a technical effect, by integratively learning diverse features extracted from image data in high-dimensional space, the learning unit achieves highly accurate object recognition that surpasses conventional simple rule-based or human visual judgment. Application fields include UI automation, manufacturing inspection, medical image diagnosis, and surveillance camera image analysis. These processes, rather than black-box AI utilization, contribute to technological advancement based on specific model structures, learning procedures, and feature design.

The matching unit can recognize objects on a screen and specifically identify their positions. The matching unit can perform image matching using methods such as feature point matching or template matching. For example, the matching unit can recognize objects on a screen and identify their positions. Thus, by recognizing objects on a screen and identifying their positions, the matching unit can improve the accuracy of image matching. Some or all of the above-described processing in the matching unit may be performed using generative AI or without using generative AI. For example, the matching unit can perform image matching using generative AI that recognizes objects on a screen and identifies their positions. Specifically, the matching unit receives as input the entire screen image tensor (e.g., 3-channel RGB, 1920×1080 pixels) or cropped images of specific regions (e.g., 224×224 pixels). The matching unit applies feature point extraction algorithms such as SIFT or ORB to these image data to generate feature descriptor vectors (e.g., 128 dimensions) for each object. Furthermore, in template matching, the matching unit uses sliding window methods or normalized cross-correlation to calculate similarity scores at each position between the template image and the input image. When using generative AI, the matching unit utilizes Vision Transformers or multimodal generative models, simultaneously inputting image tensors and object text descriptions (e.g., “red round button”) and integrating visual and linguistic features through cross-attention mechanisms to estimate positions. Outputs of the AI model include bounding box coordinates (e.g., x=120, y32 80, w=40, h=20), detected class labels (e.g., “button”), and confidence scores (e.g., 0.93). Specific examples include: input: 224×224 pixel button image→output: bounding box (x=120, y=80, w=40, h=20), confidence 0.95; or input: full screen capture→output: positions and scores of multiple objects (e.g., button 1: x=100, y=200, 0.92; button 2: x=300, y=400, 0.88). In subsequent processing, the matching unit passes the output position information and confidence to the correction unit, and if the confidence is below the threshold (e.g., 0.85), instructs re-matching or additional data collection. As a technical effect, by performing similarity calculation in high-dimensional feature space and multimodal information integration, the matching unit achieves robust object recognition and position identification resistant to environmental changes such as lighting variation, resolution differences, and UI changes, thereby greatly improving the automation accuracy, stability, and reproducibility of RPA scenarios. Application fields include automatic operation of business applications, test automation, automation tools resistant to UI changes, image-based automatic control in manufacturing, and automatic labeling of medical images. These configurations and processing procedures not only automate human tasks but also contribute to the evolution and improvement of computer-based image recognition and matching technologies themselves.

The correction unit can perform correction based on the position of the recognized object. The correction unit can perform correction using methods such as position correction or color correction. For example, the correction unit can perform correction based on the position of the recognized object. Thus, by performing correction based on the position of the recognized object, the correction unit can improve the accuracy of image matching. Some or all of the above-described processing in the correction unit may be performed using generative AI or without using generative AI. For example, the correction unit can perform correction using generative AI that performs correction based on the position of the recognized object. Specifically, the correction unit utilizes as input the bounding box coordinates (e.g., x, y, w, h) received from the matching unit, confidence scores, past matching error history (e.g., time-series array), and screen layout information (e.g., UI configuration data). The correction unit applies position correction algorithms (e.g., Kalman filter for time-series correction, local subpixel interpolation, RANSAC for outlier removal) based on this information to recalculate the object position with high accuracy. For color correction, the correction unit calculates histogram characteristics and average luminance values of the image region and automatically applies gamma correction or white balance adjustment. When using generative AI, the correction unit inputs object image tensors, position information, and past correction history to a Transformer-based time-series generative model or image correction-specialized neural network to output optimal correction parameters (e.g., position offset Δx, Δy, color correction coefficients). Example outputs of the AI model include: input: bounding box (x=120, y=80, w=40, h=20), past error history→output: corrected bounding box (x=122, y=82, w=40, h=20); or input: image with color deviation→output: color-corrected image. In subsequent processing, the correction unit passes the corrected position information and image data to the automatic execution module of the RPA scenario, and if the confidence is below the threshold, instructs re-correction or additional data collection. As a technical effect, by optimizing correction parameters in time-series history and high-dimensional feature space, the correction unit achieves robust correction processing resistant to environmental changes such as lighting variation, UI changes, and noise contamination, thereby greatly improving the accuracy, stability, and reproducibility of image matching. Application fields include automatic operation of business applications, test automation, image-based automatic control in manufacturing, and automatic labeling of medical images. These configurations and processing procedures not only automate human tasks but also contribute to the evolution and improvement of computer-based image correction technologies themselves.

The collection unit can estimate a user's emotion and adjust the timing of image data collection based on the estimated emotion of the user. For example, if the user is focused, the collection unit can shorten the collection timing to efficiently collect data. If the user is fatigued, the collection unit can lengthen the collection timing and collect data with breaks. Furthermore, if the user is relaxed, the collection unit can adjust the collection timing to match the user's pace. Thus, by adjusting the timing of image data collection based on the user's emotion, the collection unit enables efficient data collection. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the collection unit may be performed using generative AI or without using generative AI. For example, the collection unit can perform collection using generative AI that estimates the user's emotion and adjusts the collection timing based on the estimated emotion. Specifically, the collection unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The collection unit preprocesses these data to generate facial feature vectors (e.g., 68 facial landmarks), audio emotion features (e.g., MFCC, pitch), and operation pattern vectors (e.g., 10 dimensions). When using generative AI, the collection unit inputs these feature vectors to a multimodal generative model (e.g., Transformer-based) and outputs emotion labels (e.g., “focused”, “fatigued”, “relaxed”) and emotion scores (e.g., focused 0.85, fatigued 0.10, relaxed 0.05). Example outputs of the AI model include: input: face image+click frequency→output: emotion “focused”, score 0.92; or input: audio+heart rate→output: emotion “fatigued”, score 0.80. In subsequent processing, the collection unit dynamically changes the image data collection timing (e.g., every 1 second, every 5 seconds, every 10 seconds) according to the estimated emotion and instructs the collection scheduler. As a technical effect, the collection unit realizes flexible data collection control according to the user's state, preventing unnecessary data collection and increased user burden, while efficiently acquiring high-quality data at necessary timing. Application fields include human interface optimization, personalized RPA scenario generation, user state monitoring in medical and welfare fields, and educational support systems. These processes, unlike subjective human judgment or manual timing adjustment, realize multivariate data analysis and autonomous collection control by computers.

The collection unit can dynamically change the types of image data to be collected based on the user's operation history. For example, the collection unit can preferentially collect image data of buttons frequently operated by the user. The collection unit can also newly collect image data of icons that the user has never operated before. Furthermore, the collection unit can collect image data of objects used at specific times based on the user's operation history. Thus, by dynamically changing the types of image data to be collected based on the user's operation history, the collection unit can efficiently collect necessary data. Some or all of the above-described processing in the collection unit may be performed using AI or without using AI. For example, the collection unit can perform collection using an AI model that dynamically changes the types of image data to be collected by inputting the user's operation history to AI. Specifically, the collection unit receives as input the user's operation log data (e.g., button ID, number of clicks, operation time, type of operation device as time-series array). The collection unit converts these operation histories into feature vectors (e.g., operation frequency vector for each object, operation histogram for each time period). When using an AI model, the collection unit applies recurrent neural networks (RNN) or time-series clustering algorithms to analyze the user's operation patterns. Outputs of the AI model include prioritized collection object lists (e.g., button A: priority 0.95, icon B: priority 0.80), new collection candidates (e.g., icon C not previously operated), and recommended collection by time period (e.g., focus on collecting button D during 6 p.m. hour). Specific examples include: input: operation history for the past week→output: prioritized collection list (button A, icon B); or input: operation history+day-of-week information→output: collect icon E on Monday morning. In subsequent processing, the collection unit issues collection instructions to the image capture API based on the output priorities and stores the data in the collection database. As a technical effect, the collection unit realizes dynamic data collection reflecting user-specific usage trends and time-of-day variations, thereby improving the personalization and adaptability of learning models. Application fields include personalized UI automation, user behavior analysis, business process optimization, and individualized response systems in education and medical fields. These processes, unlike conventional static data collection or manual priority setting, realize time-series analysis and autonomous collection control by computers.

The collection unit can evaluate the quality of image data in real time during collection and automatically exclude data determined to be of low quality. For example, the collection unit can evaluate the resolution of collected image data in real time and exclude low-resolution data. The collection unit can also evaluate the brightness and contrast of collected image data and exclude inappropriate data. Furthermore, the collection unit can evaluate the noise level of collected image data and exclude data with high noise. Thus, by evaluating the quality of image data in real time and excluding data of low quality, the collection unit can maintain data quality. Some or all of the above-described processing in the collection unit may be performed using AI or without using AI. For example, the collection unit can perform collection using an AI model that excludes data of low quality by inputting the quality of collected image data to AI. Specifically, the collection unit receives as input image tensors immediately after collection (e.g., 3-channel RGB, 224×224 pixels) and sequentially applies resolution determination algorithms (e.g., threshold judgment of image size), brightness and contrast evaluation algorithms (e.g., average luminance value, standard deviation, histogram distribution), and noise level estimation algorithms (e.g., spatial frequency analysis, local variance calculation). The collection unit summarizes these evaluation values as a quality feature vector (e.g., 4-dimensional vector of resolution value, average luminance, contrast value, noise score) and inputs it to an AI model (e.g., convolutional neural network or fully connected network for quality judgment). The AI model outputs quality labels (e.g., “high quality”, “low quality”) or quality scores (e.g., 0.92) based on the input quality feature vector. Specific examples of AI model input and output include: input: dark image of 224×224 pixels→output: quality score 0.45 (low quality); input: noisy image→output: quality score 0.38 (low quality); input: image with appropriate brightness and contrast→output: quality score 0.95 (high quality). The collection unit automatically excludes image data if the AI model output is below a predetermined threshold (e.g., 0.80) and stores only data above the threshold in the database. In subsequent processing, the collection unit records metadata of excluded images (e.g., exclusion reason, acquisition time, device information) and saves it as a quality management log. As a technical effect, the collection unit realizes homogenization of learning dataset quality and prevention of noise contamination through real-time and automatic quality evaluation and exclusion processing, thereby greatly improving the accuracy, stability, and convergence of subsequent AI learning and image recognition processing. Application fields include data collection for medical image diagnosis, appearance inspection data collection on manufacturing lines, quality management of surveillance camera footage, and image collection for UI automation. These processes, unlike manual quality judgment or exclusion by human visual inspection, realize autonomous and consistent quality management in high-dimensional feature space by computers, contributing to the evolution and improvement of image data collection technology itself.

The collection unit can estimate a user's emotion and determine the priority of image data to be collected based on the estimated emotion of the user. For example, if the user is focused, the collection unit can preferentially collect image data of important objects. If the user is fatigued, the collection unit can preferentially collect image data of simple objects. Furthermore, if the user is relaxed, the collection unit can preferentially collect image data of objects matching the user's interests. Thus, by determining the priority of image data to be collected based on the user's emotion, the collection unit enables efficient data collection. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the collection unit may be performed using generative AI or without using generative AI. For example, the collection unit can perform collection using generative AI that estimates the user's emotion and determines the priority of image data to be collected based on the estimated emotion. Specifically, the collection unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The collection unit preprocesses these data to generate facial feature vectors (e.g., 68 facial landmarks), audio emotion features (e.g., MFCC, pitch), and operation pattern vectors (e.g., 10 dimensions). The generative AI model (e.g., Transformer-based multimodal model) inputs these feature vectors and outputs emotion labels (e.g., “focused”, “fatigued”, “relaxed”) and emotion scores (e.g., focused 0.85, fatigued 0.10, relaxed 0.05). Example outputs of the AI model include: input: face image+click frequency→output: emotion “focused”, score 0.92; or input: audio+heart rate→output: emotion “fatigued”, score 0.80. The collection unit generates an image data collection priority list (e.g., important objects, simple objects, interest objects) according to the estimated emotion and instructs the collection scheduler. In subsequent processing, the collection unit issues collection instructions to the image capture API based on the priority and stores the data in the collection database. As a technical effect, the collection unit realizes flexible data collection control according to the user's state, preventing unnecessary data collection and increased user burden, while efficiently acquiring high-quality data at necessary timing. Application fields include human interface optimization, personalized RPA scenario generation, user state monitoring in medical and welfare fields, and educational support systems. These processes, unlike subjective human judgment or manual priority setting, realize multivariate data analysis and autonomous collection control by computers, contributing to the evolution and improvement of data collection technology itself.

The collection unit can preferentially collect highly relevant image data based on the user's geographic location information during collection. For example, if the user is in a specific region, the collection unit can preferentially collect image data of objects related to that region. If the user is moving, the collection unit can collect image data of objects related to the destination. Furthermore, if the user is in a specific facility, the collection unit can preferentially collect image data of objects within that facility. Thus, by preferentially collecting highly relevant image data based on the user's geographic location information, the collection unit enables efficient data collection. Some or all of the above-described processing in the collection unit may be performed using AI or without using AI. For example, the collection unit can perform collection using an AI model that preferentially collects highly relevant image data by inputting the user's geographic location information to AI. Specifically, the collection unit receives as input GPS coordinate data (e.g., 2-dimensional vector of latitude and longitude), Wi-Fi/Bluetooth beacon information, facility ID, and time-series movement history data. The collection unit converts this location information into geographic feature vectors (e.g., current location, movement speed, duration of stay, facility type) and inputs it to an AI model (e.g., fully connected network for geographic relevance estimation or time-series RNN). The AI model outputs object lists with relevance scores (e.g., button in region A: 0.95, icon in facility B: 0.88) based on the input geographic feature vectors. Example outputs of the AI model include: input: latitude 35.6, longitude 139.7→output: region A-related object priority 0.93; input: destination facility ID 123→output: facility B-related object priority 0.90. The collection unit issues collection instructions to the image capture API based on the output priorities and stores the data in the collection database. In subsequent processing, the collection unit records collection history and geographic metadata for future optimization of collection strategies. As a technical effect, the collection unit realizes dynamic data collection according to the user's geographic situation, enabling the construction of region-specific AI models and improved field adaptability. Application fields include location-linked UI automation, on-site work support, region-specific manufacturing inspection, and tourist information systems. These processes, unlike conventional static data collection or manual region determination, realize geographic information analysis and autonomous collection control by computers, contributing to the evolution and improvement of image data collection technology itself.

The collection unit can analyze the user's social media activity during collection and collect related image data. For example, the collection unit can collect image data of objects frequently posted by the user on social media. The collection unit can also collect image data of objects related to accounts followed by the user on social media. Furthermore, the collection unit can collect image data of objects that the user has shown interest in on social media. Thus, by analyzing the user's social media activity and collecting related image data, the collection unit enables efficient data collection. Some or all of the above-described processing in the collection unit may be performed using AI or without using AI. For example, the collection unit can perform collection using an AI model that collects related image data by inputting the user's social media activity to AI. Specifically, the collection unit receives as input structured data such as the user's post history data (e.g., post text, image URL, post time), followed account list, like/share history, and interest tags. The collection unit converts these data into text feature vectors (e.g., TF-IDF, BERT embeddings), image feature vectors (e.g., 512-dimensional CNN extraction), and activity frequency vectors (e.g., number of posts for each object), and inputs them to an AI model (e.g., multimodal recommendation network or clustering model). The AI model outputs object lists with relevance scores (e.g., frequently posted object: 0.95, followed account-related object: 0.88, interest tag-matched object: 0.90) based on the input feature vectors. Example outputs of the AI model include: input: post history for the past month→output: object A priority 0.93; input: followed accounts+interest tags→output: object B priority 0.89. The collection unit issues collection instructions to the image capture API based on the output priorities and stores the data in the collection database. In subsequent processing, the collection unit links social media activity and collection history for use in training personalized AI models. As a technical effect, the collection unit realizes dynamic data collection tailored to the user's interests and preferences, thereby improving the personalization and adaptability of learning models. Application fields include personalized UI automation, user behavior analysis, advertisement recommendation, and individualized response systems in education and medical fields. These processes, unlike conventional static data collection or manual interest determination, realize multivariate data analysis and autonomous collection control by computers, contributing to the evolution and improvement of image data collection technology itself.

The learning unit can estimate a user's emotion and select learning data based on the estimated emotion of the user. For example, if the user is focused, the learning unit can select high-difficulty learning data. If the user is fatigued, the learning unit can select simple learning data. Furthermore, if the user is relaxed, the learning unit can select learning data matching the user's interests. Thus, by selecting learning data based on the user's emotion, the learning unit enables efficient learning. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the learning unit may be performed using generative AI or without using generative AI. For example, the learning unit can perform learning using generative AI that estimates the user's emotion and selects learning data based on the estimated emotion. Specifically, the learning unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The learning unit preprocesses these data to generate facial feature vectors (e.g., 68 facial landmarks), audio emotion features (e.g., MFCC, pitch), and operation pattern vectors (e.g., 10 dimensions). The learning unit inputs these feature vectors to a generative AI model (e.g., Transformer-based multimodal model) and outputs emotion labels (e.g., “focused”, “fatigued”, “relaxed”) and emotion scores (e.g., focused 0.85, fatigued 0.10, relaxed 0.05). Example outputs of the AI model include: input: face image+click frequency→output: emotion “focused”, score 0.92; or input: audio+heart rate→output: emotion “fatigued”, score 0.80. According to the estimated emotion, the learning unit selects image datasets with difficulty labels or interest tags from the learning database, and, for example, in the “focused” state, preferentially extracts high-difficulty images (e.g., complex UI components or hard-to-distinguish icon images); in the “fatigued” state, simple images (e.g., clear contours or high-contrast button images); and in the “relaxed” state, images based on the user's past interest history (e.g., icons of specific categories). The learning unit inputs the selected image data to learning algorithms (e.g., CNN, Vision Transformer, SVM, etc.) and performs learning processes such as feature extraction, classification, and regression. Example inputs and outputs of the AI model include: input: high-difficulty button image→output: class label “button”, bounding box (x=120, y=80, w=40, h=20), confidence 0.95; or input: icon image with interest tag→output: class label “icon”, score 0.90. In subsequent processing, the learning unit records learning progress and accuracy evaluation indices (e.g., loss value, accuracy, recall) and analyzes learning effects for each emotional state. As a technical effect, the learning unit greatly improves learning efficiency, model accuracy, and user adaptability through dynamic selection of learning data according to the user's state. Application fields include personalized UI automation, educational support AI, medical image diagnosis support, and user state-adaptive RPA scenario generation. These processes, unlike subjective human judgment or manual data selection, realize multivariate data analysis and autonomous learning control by computers, contributing to the evolution and improvement of learning data selection technology itself.

The learning unit can optimize the learning algorithm by referring to past learning data during learning. For example, the learning unit can evaluate the performance of past learning data and select the optimal algorithm. The learning unit can also analyze errors in past learning data and identify points for algorithm improvement. Furthermore, the learning unit can adjust algorithm parameters based on successful cases in past learning data. Thus, by optimizing the learning algorithm by referring to past learning data, the learning unit can improve learning accuracy. Some or all of the above-described processing in the learning unit may be performed using AI or without using AI. For example, the learning unit can perform learning using an AI model that optimizes the learning algorithm by inputting past learning data to AI. Specifically, the learning unit receives as input past learning datasets (e.g., image tensors, labels, learning time, loss values, accuracy history, and other structured data). The learning unit extracts performance indicators (e.g., accuracy transition per epoch, loss function values, misclassification example list) and error distributions (e.g., error histogram per class) from these data. The learning unit inputs these feature vectors to an AI model (e.g., meta-learning network or hyperparameter optimization algorithm) and outputs optimal learning algorithm selection (e.g., CNN, Vision Transformer, SVM, etc.), hyperparameter settings (e.g., learning rate, batch size, regularization coefficient), and improvement points (e.g., addition of data augmentation methods, change of loss function). Example outputs of the AI model include: input: past 10 learning histories→output: optimal algorithm “Vision Transformer”, learning rate 0.001, batch size 64; or input: class with many misclassifications→output: recommended data augmentation “rotation/flip”. The learning unit automatically updates the learning algorithm and parameters based on the output optimization results and executes retraining. In subsequent processing, the learning unit evaluates the results after optimization and records indicators such as accuracy, loss, and recall, thereby constructing a continuous algorithm improvement cycle. As a technical effect, the learning unit greatly improves model convergence, accuracy, and generalization performance through dynamic algorithm optimization utilizing past learning history. Application fields include continual learning AI, medical image diagnosis support, manufacturing inspection AI, and personalized UI automation. These processes, unlike conventional static algorithm selection or manual parameter adjustment, realize autonomous and continuous learning algorithm optimization by computers, contributing to the evolution and improvement of AI learning technology itself.

The learning unit can improve the versatility of the model by combining image data of different resolutions and angles during learning. For example, the learning unit can combine image data of different resolutions during learning to reduce the model's dependency on resolution. The learning unit can also combine image data taken from different angles during learning to reduce the model's dependency on angle. Furthermore, the learning unit can combine image data taken under different environmental conditions during learning to reduce the model's dependency on environment. Thus, by combining image data of different resolutions and angles during learning, the learning unit can improve the versatility of the model. Some or all of the above-described processing in the learning unit may be performed using generative AI or without using generative AI. For example, the learning unit can input image data of different resolutions and angles to generative AI and perform learning. Specifically, the learning unit receives as input image tensors acquired at various resolutions (e.g., 224×224, 512×512, 1024×1024 pixels), various angles (e.g., 0°, 30°, 60°, 90°), and different environmental conditions (e.g., day/night, lighting changes, background differences). The learning unit applies normalization, resizing, contrast correction, etc., in the preprocessing unit to these image data and integrates them as a learning dataset. The learning unit uses architectures such as convolutional neural networks (CNN), Vision Transformers, or multi-scale networks to extract feature vectors (e.g., 512 dimensions) from input images and outputs classification labels and bounding box coordinates. When using generative AI, the learning unit automatically generates variation images of new resolutions, angles, and environmental conditions from input images for data augmentation. Example inputs and outputs of the AI model include: input: 224×224 pixel button image+90° rotation→output: class label “button”, score 0.93; or input: icon image in low-light environment→output: bounding box (x=100, y=50, w=40, h=20), confidence 0.90. The learning unit mixes images of different resolutions, angles, and environmental conditions in batches and applies mini-batch normalization or domain adaptation layers to enhance the versatility and robustness of the model. In subsequent processing, the learning unit deploys the trained model to the matching unit or correction unit to achieve high-precision recognition and correction for diverse input images in actual operation. As a technical effect, by maximizing the diversity of image data, the learning unit enables the construction of general-purpose AI models resistant to resolution, angle, and environmental changes, achieving significant improvements in accuracy and stability compared to conventional single-condition-dependent models. Application fields include UI automation, manufacturing inspection, surveillance camera image analysis, and medical image diagnosis. These processes, unlike manual data augmentation or single-condition learning by humans, realize automatic and comprehensive data integration and learning control by computers, contributing to the evolution and improvement of AI learning technology itself.

The learning unit can estimate a user's emotion and adjust the frequency of learning based on the estimated emotion of the user. For example, if the user is focused, the learning unit can increase the frequency of learning to efficiently advance learning. If the user is fatigued, the learning unit can decrease the frequency of learning and proceed with learning with breaks. Furthermore, if the user is relaxed, the learning unit can adjust the frequency of learning to match the user's pace. Thus, by adjusting the frequency of learning based on the user's emotion, the learning unit enables efficient learning. Emotion estimation is realized using, for example, an emotion engine or generative AI with emotion estimation functionality. Generative AI may include text generation AI (e.g., LLM) or multimodal generative AI, but is not limited to these examples. Some or all of the above-described processing in the learning unit may be performed using generative AI or without using generative AI. For example, the learning unit can perform learning using generative AI that estimates the user's emotion and adjusts the frequency of learning based on the estimated emotion. Specifically, the learning unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The learning unit preprocesses these data to generate facial feature vectors (e.g., 68 facial landmarks), audio emotion features (e.g., MFCC, pitch), and operation pattern vectors (e.g., 10 dimensions). The learning unit inputs these feature vectors to a generative AI model (e.g., Transformer-based multimodal model) and outputs emotion labels (e.g., “focused”, “fatigued”, “relaxed”) and emotion scores (e.g., focused 0.85, fatigued 0.10, relaxed 0.05). Example outputs of the AI model include: input: face image+click frequency→output: emotion “focused”, score 0.92; or input: audio+heart rate→output: emotion “fatigued”, score 0.80. According to the estimated emotion, the learning unit dynamically instructs the learning scheduler on learning frequency (e.g., every 1 minute, every 5 minutes, every 10 minutes) and batch size, performing high-frequency, large-batch learning in the “focused” state, low-frequency, small-batch learning in the “fatigued” state, and pace adjustment based on the user's past learning history in the “relaxed” state. In subsequent processing, the learning unit records learning progress and accuracy evaluation indices (e.g., loss value, accuracy, recall) and analyzes learning effects for each emotional state. As a technical effect, the learning unit greatly improves learning efficiency, model accuracy, and user adaptability through dynamic learning frequency control according to the user's state. Application fields include personalized UI automation, educational support AI, medical image diagnosis support, and user state-adaptive RPA scenario generation. These processes, unlike subjective human judgment or manual frequency adjustment, realize multivariate data analysis and autonomous learning control by computers, contributing to the evolution and improvement of learning frequency control technology itself.

The learning unit can weight learning data based on the timing of image data collection during learning. For example, the learning unit can assign higher weights to the latest image data during learning to maintain the model's currency. The learning unit can assign lower weights to older image data during learning to reduce the model's dependency on past data. Furthermore, the learning unit can assign weights to image data collected during specific periods to adjust the model's dependency on data from specific periods. Thus, by weighting learning data based on the timing of image data collection, the learning unit can maintain the model's currency. Some or all of the above-described processing in the learning unit may be performed using AI or without using AI. For example, the learning unit can perform learning using an AI model that weights learning data by inputting the timing of image data collection to AI. Specifically, the learning unit receives as input image data and its collection time metadata (e.g., timestamp, collection date, elapsed days). The learning unit converts these data into time-series feature vectors (e.g., elapsed days per image, collection period label) and inputs them to an AI model (e.g., time-series weighting network or attention mechanism-equipped CNN). The AI model outputs weight coefficients for each image data (e.g., latest data 0.95, data from one month ago 0.80, data from one year ago 0.60) based on the input feature vectors. Example outputs of the AI model include: input: image A (collected 1 day ago)→output: weight 0.98; input: image B (collected 1 year ago)→output: weight 0.60. The learning unit performs learning emphasizing the latest data using a weighted loss function (e.g., weighted cross-entropy loss) to maintain the model's currency and adaptability. In subsequent processing, the learning unit records weighting history and learning accuracy transitions and analyzes the model's performance changes over time. As a technical effect, the learning unit maintains the latest model that can quickly adapt to environmental changes and UI updates through weighting learning considering the timing of image data collection, preventing accuracy degradation due to dependency on past data. Application fields include UI automation, manufacturing inspection, surveillance camera image analysis, and medical image diagnosis. These processes, unlike conventional static data usage or manual weighting, realize time-series data analysis and autonomous weighting control by computers, contributing to the evolution and improvement of AI learning technology itself.

The learning unit can integrate image data collected from different devices during learning. For example, the learning unit can integrate image data collected from a smartphone and image data collected from a tablet for learning. Additionally, the learning unit can integrate image data collected from a digital camera and image data collected from a webcam for learning. Furthermore, the learning unit can integrate image data collected from a drone and image data collected from a fixed camera for learning. By integrating image data collected from different devices for learning, the learning unit can improve the versatility of the model. Some or all of the above-described processes in the learning unit may be performed using AI or without using AI. For example, the learning unit can input image data collected from different devices into AI and perform learning using an AI model that integrates such data. Specifically, the learning unit receives, as input, image tensors for each device type (e.g., smartphone: 224×224 pixels, tablet: 512×512 pixels, digital camera: 1024×1024 pixels, drone: 640×480 pixels) and metadata (e.g., device ID, shooting conditions, resolution information). The learning unit performs resizing, normalization, color space conversion, etc., in the preprocessing unit, and extracts feature vectors (e.g., 512 dimensions) for each device type. The learning unit uses architectures such as multi-domain learning networks, domain adaptation layers in CNNs, or Vision Transformers to integratively learn image features originating from different devices. Examples of AI model input/output include: input: smartphone image+device ID→output: class label “button”, score 0.93; or input: drone image+shooting altitude→output: bounding box (x=100, y=50, w=40, h=20), confidence 0.90. The learning unit applies domain adaptation loss or adversarial learning to reduce distribution differences between devices and improve overall recognition accuracy. As a subsequent process, the learning unit deploys the trained model to the matching unit or correction unit, thereby enabling highly accurate recognition and correction for diverse device images during actual operation. As a technical effect, the learning unit enables the construction of a general-purpose AI model with low device dependency by integrative learning of heterogeneous device images, achieving significant improvements in accuracy and stability compared to conventional single-device-dependent models. Application fields include UI automation, manufacturing inspection, surveillance camera image analysis, and medical image diagnosis. These processes, unlike manual data integration or single-device learning by humans, realize automatic and comprehensive data integration and learning control by computers, leading to the evolution and improvement of AI learning technology itself.

The matching unit can estimate a user's emotion and adjust matching criteria based on the estimated emotion of the user. For example, the matching unit can apply strict matching criteria when the user is focused. Additionally, the matching unit can apply relaxed matching criteria when the user is fatigued. Furthermore, the matching unit can apply matching criteria tailored to the user's pace when the user is relaxed. By adjusting matching criteria based on the user's emotion, the matching unit enables efficient matching. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the matching unit may be performed using generative AI or without using generative AI. For example, the matching unit can use generative AI to estimate the user's emotion and adjust matching criteria based on the estimated emotion to perform matching. Specifically, the matching unit receives, as input, feature vectors representing the user's emotional state (e.g., facial image tensor 128×128 pixels, 1-second 16 kHz audio waveform data, 10-dimensional operation log vector, biometric sensor data such as heart rate or skin conductance). The matching unit preprocesses these diverse time-series data to generate facial feature vectors (e.g., 68 facial landmarks), voice emotion features (e.g., MFCC, pitch), and operation pattern vectors. The generative AI model (e.g., Transformer-based multimodal model) takes these feature vectors as input and outputs emotion labels (e.g., “focused,” “fatigued,” “relaxed”) and emotion scores (e.g., focused 0.85, fatigued 0.10, relaxed 0.05). Examples of AI model output include: input: facial image+click frequency→output: emotion“focused,” score 0.92; or input: voice+heart rate→output: emotion “fatigued,” score 0.80. The matching unit dynamically adjusts thresholds and tolerance parameters in image matching processing according to the estimated emotion. For example, in a “focused” state, the cosine similarity threshold is set to 0.90 or higher for strict matching that minimizes false detections. In a “fatigued” state, the threshold is relaxed to around 0.80 to allow some errors and increase the matching success rate. In a “relaxed” state, individually optimized criteria are applied based on the user's past operation history and objects of interest. Examples of AI model input/output include: input: 224×224 pixel button image+emotion “focused”→output: bounding box (x=120, y=80, w=40, h=20), confidence 0.95 (strict criteria); or input: same image+emotion “fatigued”→output: bounding box (x=122, y=82, w=40, h=20), confidence 0.85 (relaxed criteria). As a subsequent process, the matching unit passes the output position information and confidence to the correction unit, and if the confidence is below the threshold, instructs re-matching or additional data collection. As a technical effect, the matching unit achieves both reduced false detection rate and optimized user load through dynamic matching criteria control according to the user's state, greatly improving automation accuracy, stability, and user adaptability in RPA scenarios. Application fields include personalized UI automation, educational support AI, medical image diagnosis support, and user state-adaptive RPA scenario generation. These processes, unlike subjective human judgment or manual criteria adjustment, realize multivariate data analysis and autonomous matching criteria control by computers, leading to the evolution and improvement of image matching technology itself.

The matching unit can improve matching accuracy by specifically considering interrelationships among image data during matching. For example, the matching unit can perform matching by considering spatial relationships between image data to improve accuracy. Additionally, the matching unit can perform matching by considering color similarity between image data to improve accuracy. Furthermore, the matching unit can perform matching by considering shape similarity between image data to improve accuracy. By considering interrelationships among image data during matching, the matching unit can improve matching accuracy. Some or all of the above-described processes in the matching unit may be performed using AI or without using AI. For example, the matching unit can input interrelationships among image data into AI and perform matching using an AI model that improves matching accuracy. Specifically, the matching unit receives, as input, multiple image tensors (e.g., 3-channel RGB, 224×224 pixels×N images), and extracts spatial relationships between images (e.g., relative distance vectors of bounding box coordinates), color space features (e.g., mean RGB values, histogram distributions), and shape features (e.g., contour extraction vectors, Hu moments). The matching unit generates a multidimensional feature vector integrating these features (e.g., position: 8 dimensions+color: 6 dimensions+shape: 16 dimensions=30 dimensions) and inputs it into an AI model (e.g., graph neural network or multimodal fusion network). The AI model constructs a relationship graph among images and calculates similarity between nodes as edge weights for position, color, and shape. AI model outputs include a matching score matrix (e.g., similarity between image i and image j: 0.92), and an optimal matching pair list (e.g., image 1-image 3, image 2-image 5). Specific examples include: input: two button images (position difference: 2 pixels, color difference: 0.01, shape match: 0.98)→output: matching score 0.95; or input: multiple icon images→output: optimal matching pair list (icon A-icon B, score 0.93). As a subsequent process, the matching unit passes the output matching results to the correction unit, and if the confidence is below the threshold, instructs re-matching or additional data collection. As a technical effect, the matching unit achieves high-precision matching that surpasses conventional simple pixel comparison or manual visual judgment by integratively analyzing multidimensional interrelationships among images in a high-dimensional feature space, enabling robust image recognition resistant to environmental changes such as lighting variation, color shift, and shape change. Application fields include manufacturing inspection, medical image diagnosis, surveillance camera image analysis, and UI automation. These processes, rather than black-box AI usage, bring technological advancement based on specific feature design and relationship analysis.

The matching unit can perform matching by combining image data of different resolutions and angles during matching. For example, the matching unit can perform matching by combining image data of different resolutions to improve accuracy. Additionally, the matching unit can perform matching by combining image data taken from different angles to improve accuracy. Furthermore, the matching unit can perform matching by combining image data taken under different environmental conditions to improve accuracy. By combining image data of different resolutions and angles during matching, the matching unit can improve matching accuracy. Some or all of the above-described processes in the matching unit may be performed using AI or without using AI. For example, the matching unit can input image data of different resolutions and angles into AI and perform matching. Specifically, the matching unit receives, as input, image tensors acquired at various resolutions (e.g., 224×224, 512×512, 1024×1024 pixels), various angles (e.g., 0°, 30°, 60°, 90°), and different environmental conditions (e.g., day/night, lighting changes, background differences). The matching unit performs normalization, resizing, contrast correction, etc., in the preprocessing unit, and generates robust feature vectors (e.g., 512 dimensions) for resolution, angle, and environmental conditions in the feature extraction layer (e.g., CNN, Vision Transformer). The AI model integrates feature vectors of multiple resolutions and angles, and calculates optimal matching scores using multi-scale similarity computation and attention mechanisms. Examples of AI model input/output include: input: 224×224 pixel button image+90° rotated image→output: matching score 0.93; or input: low-light icon image+high-light image→output: matching score 0.90. The matching unit mixes images under different conditions in batches and applies domain adaptation layers or mini-batch normalization to achieve robust matching against environmental changes. As a subsequent process, the matching unit passes the output matching results to the correction unit, and if the confidence is below the threshold, instructs re-matching or additional data collection. As a technical effect, the matching unit enables the construction of a general-purpose matching technology robust to resolution, angle, and environmental changes by maximizing the diversity of image data, achieving significant improvements in accuracy and stability compared to conventional single-condition-dependent matching. Application fields include UI automation, manufacturing inspection, surveillance camera image analysis, and medical image diagnosis. These processes, unlike manual data augmentation or single-condition matching by humans, realize automatic and comprehensive data integration and matching control by computers, leading to the evolution and improvement of image matching technology itself.

The matching unit can estimate a user's emotion and adjust the order in which matching results are displayed based on the estimated emotion of the user. For example, the matching unit can prioritize the display of important matching results when the user is focused. Additionally, the matching unit can prioritize the display of simple matching results when the user is fatigued. Furthermore, the matching unit can prioritize the display of matching results tailored to the user's interests when the user is relaxed. By adjusting the display order of matching results based on the user's emotion, the matching unit enables efficient result presentation. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the matching unit may be performed using generative AI or without using generative AI. For example, the matching unit can use generative AI to estimate the user's emotion and adjust the display order of matching results based on the estimated emotion to present results. Specifically, the matching unit receives, as input, feature vectors representing the user's emotional state (e.g., facial image tensor 128×128 pixels, audio waveform data, operation log, heart rate, etc.), and uses a generative AI model (e.g., Transformer-based multimodal model) to output emotion labels (e.g., “focused,” “fatigued,” “relaxed”) and emotion scores. The matching unit generates a matching result list (e.g., matching scores for each object, importance labels, difficulty labels, interest tags) and dynamically determines the display order according to the emotional state. For example, in a “focused” state, matching results of high importance (e.g., essential buttons or icons for business) are displayed at the top; in a “fatigued” state, simple matching results (e.g., objects with clear contours or high contrast) are prioritized; in a “relaxed” state, matching results based on the user's past interest history or custom tags are displayed at the top. Examples of AI model input/output include: input: facial image+click frequency→output: emotion “focused,” score 0.92, matching result list (by importance); or input: voice+heart rate→output: emotion “fatigued,” score 0.80, matching result list (by simplicity). As a subsequent process, the matching unit passes the display order decision result to the UI display module and presents matching results to the user in the optimal order. As a technical effect, the matching unit achieves flexible result display control according to the user's state, preventing information overload and erroneous operations, and improving user satisfaction, thereby greatly enhancing automation efficiency and user adaptability in RPA scenarios. Application fields include personalized UI automation, educational support AI, medical image diagnosis support, and user state-adaptive RPA scenario generation. These processes, unlike subjective human judgment or manual display order adjustment, realize multivariate data analysis and autonomous result display control by computers, leading to the evolution and improvement of image matching result display technology itself.

The matching unit can perform matching by specifically considering the geographic distribution of image data during matching. For example, the matching unit can perform matching for each region by considering the geographic distribution of image data. Additionally, the matching unit can prioritize matching of data from specific regions by considering the geographic distribution of image data. Furthermore, the matching unit can integrate data from different regions and perform matching by considering the geographic distribution of image data. By considering the geographic distribution of image data during matching, the matching unit can improve matching accuracy for each region. Some or all of the above-described processes in the matching unit may be performed using AI or without using AI. For example, the matching unit can input the geographic distribution of image data into AI and perform matching. Specifically, the matching unit receives, as input, image data and its geographic metadata (e.g., GPS coordinates, facility ID, acquisition time, region label). The matching unit converts this geographic information into geographic feature vectors (e.g., latitude/longitude: 2 dimensions, region category, stay duration, movement history) and inputs them into an AI model (e.g., fully connected network or time-series RNN for geographic relevance estimation). The AI model outputs region-specific matching priorities and scores based on the input geographic feature vectors, and applies region-specific matching algorithms (e.g., different thresholds or feature weighting for each region). Examples of AI model input/output include: input: image A (latitude 35.6, longitude 139.7)→output: region A priority 0.93; or input: image B (facility ID 123)→output: facility B priority 0.90. The matching unit aggregates matching results for each region, prioritizes matching of data from specific regions, or integrates data from multiple regions to improve matching accuracy. As a subsequent process, the matching unit passes region-specific matching results to the correction unit or UI display module, and utilizes them for constructing region-specific AI models and improving on-site adaptability. As a technical effect, the matching unit enables the construction of region-specific AI models and improvement of on-site adaptability through dynamic matching control according to geographic conditions, realizing geographic information analysis and autonomous matching control by computers, which differs from conventional static matching or manual region determination, and leads to the evolution and improvement of image matching technology itself. Application fields include location-linked UI automation, on-site work support, region-specific manufacturing inspection, and tourist guide systems.

The matching unit can improve matching accuracy by referring to related literature during matching. For example, the matching unit can adjust matching criteria based on information from related literature. Additionally, the matching unit can improve matching algorithms based on information from related literature. Furthermore, the matching unit can optimize matching parameters based on information from related literature. By referring to related literature during matching, the matching unit can improve matching accuracy. Some or all of the above-described processes in the matching unit may be performed using AI or without using AI. For example, the matching unit can input information from related literature into AI and perform matching using an AI model that improves matching accuracy. Specifically, the matching unit receives, as input, text data from related literature (e.g., paper PDFs, patent specifications, technical blog articles), algorithm descriptions, and parameter recommendation lists as structured or unstructured data. The matching unit vectorizes these literature data using natural language processing models (e.g., BERT, LLM), and performs technical keyword extraction, algorithm structure analysis, and parameter candidate list generation. The AI model outputs matching criteria (e.g., similarity threshold, feature selection), algorithm selection (e.g., CNN, Vision Transformer, SIFT), and parameter optimization (e.g., learning rate, batch size, regularization coefficient) based on the extracted knowledge base. Examples of AI model input/output include: input: latest image matching paper→output: recommended algorithm “Vision Transformer,” threshold 0.88; or input: patent specification →output: recommended feature weighting “color+shape.” The matching unit automatically updates matching algorithms and parameters based on the output optimization results and executes re-matching. As a subsequent process, the matching unit passes the optimized matching results to the correction unit or learning unit, and builds a continuous algorithm improvement cycle. As a technical effect, the matching unit greatly improves matching accuracy, versatility, and adaptability by dynamically incorporating the latest technical knowledge and external knowledge. Application fields include continual learning AI, medical image diagnosis support, manufacturing inspection AI, and personalized UI automation. These processes, unlike conventional static algorithm selection or manual parameter adjustment, realize autonomous and continuous matching algorithm optimization by computers, leading to the evolution and improvement of image matching technology itself.

The correction unit can estimate a user's emotion and adjust the correction method based on the estimated emotion of the user. For example, the correction unit can apply a strict correction method when the user is focused. Additionally, the correction unit can apply a simple correction method when the user is fatigued. Furthermore, the correction unit can apply a correction method tailored to the user's pace when the user is relaxed. By adjusting the correction method based on the user's emotion, the correction unit enables efficient correction. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the correction unit may be performed using generative AI or without using generative AI. For example, the correction unit can use generative AI to estimate the user's emotion and adjust the correction method based on the estimated emotion to perform correction. Specifically, the correction unit receives, as input, various time-series data such as facial expression images (e.g., facial image tensor 128×128 pixels), audio waveform data (e.g., 1-second 16 kHz sample), operation logs (e.g., click frequency, mouse movement speed), and biometric sensor data (e.g., heart rate, skin conductance). The correction unit preprocesses these data to generate facial feature vectors (e.g., 68 facial landmarks), voice emotion features (e.g., MFCC, pitch), and operation pattern vectors (e.g., 10 dimensions). The generative AI model (e.g., Transformer-based multimodal model) takes these feature vectors as input and outputs emotion labels (e.g., “focused,” “fatigued,” “relaxed”) and emotion scores (e.g., focused 0.85, fatigued 0.10, relaxed 0.05). Examples of AI model output include: input: facial image+click frequency→output: emotion “focused,” score 0.92; or input: voice+heart rate→output: emotion “fatigued,” score 0.80. The correction unit dynamically changes correction algorithm selection and parameter settings according to the estimated emotion. For example, in a “focused” state, high-precision correction such as time-series correction using a Kalman filter or subpixel interpolation is applied, and thresholds for position offset and color correction coefficients are strictly set. In a “fatigued” state, simple median correction or histogram equalization with low computational load is selected to reduce user burden. In a “relaxed” state, individually optimized correction parameters are applied based on the user's past correction history and operation tendencies. Examples of AI model input/output include: input: bounding box (x=120, y=80, w=40, h=20)+emotion “focused”→output: corrected bounding box (x=121, y=81, w=40, h=20); or input: color-shifted image+emotion“fatigued”→output: simply color-corrected image. As a subsequent process, the correction unit passes corrected position information and image data to the automatic execution module of the RPA scenario, and if the confidence is below the threshold, instructs re-correction or additional data collection. As a technical effect, the correction unit greatly improves correction accuracy, computational efficiency, and user adaptability through dynamic correction method control according to the user's state. Application fields include personalized UI automation, educational support AI, medical image diagnosis support, and user state-adaptive RPA scenario generation. These processes, unlike subjective human judgment or manual correction method selection, realize multivariate data analysis and autonomous correction control by computers, leading to the evolution and improvement of image correction technology itself.

The correction unit can select a specific correction method by referring to past correction history during correction. For example, the correction unit can select the optimal correction method based on past correction history. Additionally, the correction unit can analyze errors in past correction history to identify areas for improvement in correction methods. Furthermore, the correction unit can adjust correction method parameters based on successful cases in past correction history. By selecting the optimal correction method by referring to past correction history, the correction unit can improve correction accuracy. Some or all of the above-described processes in the correction unit may be performed using AI or without using AI. For example, the correction unit can input past correction history into AI and perform correction using an AI model that selects the optimal correction method. Specifically, the correction unit receives, as input, past correction history data (e.g., bounding box coordinates before and after correction, correction time, correction algorithm type, correction parameters, correction error values, confidence scores, environmental condition metadata). The correction unit extracts performance indicators (e.g., error trends per correction, accuracy by algorithm, success rate by environmental condition) and error distributions (e.g., correction error histograms, outlier lists) from these history data. The AI model (e.g., meta-learning network or hyperparameter optimization algorithm) takes these feature vectors as input and outputs optimal correction algorithm selection (e.g., Kalman filter, subpixel interpolation, RANSAC), parameter settings (e.g., smoothing coefficient, outlier threshold), and areas for improvement (e.g., introduction of new algorithms, adjustment of parameter ranges). Examples of AI model output include: input: past 10 correction histories→output: optimal algorithm “Kalman filter,” smoothing coefficient 0.8; or input: cases with large errors→output: outlier removal recommendation “RANSAC.” The correction unit automatically updates correction algorithms and parameters based on the output optimization results and executes re-correction. As a subsequent process, the correction unit records optimized correction results and continuously analyzes indicators such as accuracy, error, and reproducibility, building an algorithm improvement cycle. As a technical effect, the correction unit greatly improves correction accuracy, convergence, and generalization performance through dynamic algorithm optimization utilizing past correction history. Application fields include continual learning image correction, medical image diagnosis support, manufacturing inspection AI, and personalized UI automation. These processes, unlike conventional static algorithm selection or manual parameter adjustment, realize autonomous and continuous correction algorithm optimization by computers, leading to the evolution and improvement of image correction technology itself.

The correction unit can perform correction by combining image data of different resolutions and angles during correction. For example, the correction unit can perform correction by combining image data of different resolutions to improve accuracy. Additionally, the correction unit can perform correction by combining image data taken from different angles to improve accuracy. Furthermore, the correction unit can perform correction by combining image data taken under different environmental conditions to improve accuracy. By combining image data of different resolutions and angles during correction, the correction unit can improve correction accuracy. Some or all of the above-described processes in the correction unit may be performed using AI or without using AI. For example, the correction unit can input image data of different resolutions and angles into AI and perform correction. Specifically, the correction unit receives, as input, image tensors acquired at various resolutions (e.g., 224×224, 512×512, 1024×1024 pixels), various angles (e.g., 0°, 30°, 60°, 90°), and different environmental conditions (e.g., day/night, lighting changes, background differences). The correction unit performs normalization, resizing, contrast correction, etc., in the preprocessing unit and integrates them into the correction algorithm. The AI model (e.g., multi-scale correction network or CNN with domain adaptation layer) extracts feature vectors (e.g., 512 dimensions) for different resolutions, angles, and environmental conditions and analyzes them integratively to output optimal correction parameters (e.g., position offset, color correction coefficient, scale correction value). Examples of AI model input/output include: input: 224×224 pixel button image+90° rotated image→output: corrected bounding box (x=121, y=81, w=40, h=20); or input: low-light icon image+high-light image→output: color-corrected image. The correction unit mixes images under different conditions in batches and applies mini-batch normalization or domain adaptation layers to achieve robust correction against environmental changes. As a subsequent process, the correction unit passes corrected position information and image data to the automatic execution module of the RPA scenario, and if the confidence is below the threshold, instructs re-correction or additional data collection. As a technical effect, the correction unit enables the construction of a general-purpose correction technology robust to resolution, angle, and environmental changes by maximizing the diversity of image data, achieving significant improvements in accuracy and stability compared to conventional single-condition-dependent correction. Application fields include UI automation, manufacturing inspection, surveillance camera image analysis, and medical image diagnosis. These processes, unlike manual data augmentation or single-condition correction by humans, realize automatic and comprehensive data integration and correction control by computers, leading to the evolution and improvement of image correction technology itself.

The correction unit can estimate a user's emotion and determine the priority of correction based on the estimated emotion of the user. For example, the correction unit can prioritize important corrections when the user is focused. Additionally, the correction unit can prioritize simple corrections when the user is fatigued. Furthermore, the correction unit can prioritize corrections tailored to the user's pace when the user is relaxed. By determining the priority of correction based on the user's emotion, the correction unit enables efficient correction. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the correction unit may be performed using generative AI or without using generative AI. For example, the correction unit can use generative AI to estimate the user's emotion and determine the priority of correction based on the estimated emotion to perform correction. Specifically, the correction unit receives, as input, various time-series data such as facial expression images (e.g., facial image tensor 128×128 pixels), audio waveform data (e.g., 1-second 16 kHz sample), operation logs (e.g., click frequency, mouse movement speed), and biometric sensor data (e.g., heart rate, skin conductance). The correction unit preprocesses these data to generate facial feature vectors (e.g., 68 facial landmarks), voice emotion features (e.g., MFCC, pitch), and operation pattern vectors (e.g., 10 dimensions). The generative AI model (e.g., Transformer-based multimodal model) takes these feature vectors as input and outputs emotion labels (e.g., “focused,” “fatigued,” “relaxed”) and emotion scores (e.g., focused 0.85, fatigued 0.10, relaxed 0.05). Examples of AI model output include: input: facial image+click frequency→output: emotion “focused,” score 0.92; or input: voice+heart rate→output: emotion “fatigued,” score 0.80. The correction unit generates a correction target list (e.g., important objects, simple objects, objects of interest) according to the estimated emotion and instructs the correction scheduler. For example, in a “focused” state, correction of essential buttons or icons for business is prioritized; in a “fatigued” state, correction of objects with clear contours or high contrast is prioritized; in a “relaxed” state, correction based on the user's past interest history or custom tags is prioritized. As a subsequent process, the correction unit applies correction algorithms according to priority and passes correction results to the automatic execution module of the RPA scenario. As a technical effect, the correction unit achieves flexible correction priority control according to the user's state, efficiently realizing high-quality correction at necessary timing while preventing unnecessary corrections and increased user burden. Application fields include human interface optimization, personalized RPA scenario generation, user state monitoring in medical and welfare fields, and educational support systems. These processes, unlike subjective human judgment or manual priority setting, realize multivariate data analysis and autonomous correction control by computers, leading to the evolution and improvement of image correction technology itself.

The correction unit can perform correction by considering the geographic distribution of image data during correction. For example, the correction unit can perform correction for each region by considering the geographic distribution of image data. Additionally, the correction unit can prioritize correction of data from specific regions by considering the geographic distribution of image data. Furthermore, the correction unit can integrate data from different regions and perform correction by considering the geographic distribution of image data. By considering the geographic distribution of image data during correction, the correction unit can improve correction accuracy for each region. Some or all of the above-described processes in the correction unit may be performed using AI or without using AI. For example, the correction unit can input the geographic distribution of image data into AI and perform correction. Specifically, the correction unit receives, as input, image data and its geographic metadata (e.g., GPS coordinates, facility ID, acquisition time, region label). The correction unit converts this geographic information into geographic feature vectors (e.g., latitude/longitude: 2 dimensions, region category, stay duration, movement history) and inputs them into an AI model (e.g., fully connected network or time-series RNN for geographic relevance estimation). The AI model outputs region-specific correction priorities and correction parameters (e.g., region A: enhanced color correction, region B: emphasis on position correction) based on the input geographic feature vectors, and applies region-specific correction algorithms (e.g., different thresholds or feature weighting for each region). Examples of AI model input/output include: input: image A (latitude 35.6, longitude 139.7)→output: region A priority 0.93, enhanced color correction; or input: image B (facility ID 123)→output: facility B priority 0.90, emphasis on position correction. The correction unit aggregates correction results for each region, prioritizes correction of data from specific regions, or integrates data from multiple regions to improve correction accuracy. As a subsequent process, the correction unit passes region-specific correction results to the automatic execution module of the RPA scenario or the learning unit, and utilizes them for constructing region-specific AI models and improving on-site adaptability. As a technical effect, the correction unit enables the construction of region-specific AI models and improvement of on-site adaptability through dynamic correction control according to geographic conditions, realizing geographic information analysis and autonomous correction control by computers, which differs from conventional static correction or manual region determination, and leads to the evolution and improvement of image correction technology itself. Application fields include location-linked UI automation, on-site work support, region-specific manufacturing inspection, and tourist guide systems.

The correction unit can improve correction accuracy by referring to specific related literature during correction. For example, the correction unit can adjust correction criteria based on information from related literature. Additionally, the correction unit can improve correction algorithms based on information from related literature. Furthermore, the correction unit can optimize correction parameters based on information from related literature. By referring to related literature during correction, the correction unit can improve correction accuracy. Some or all of the above-described processes in the correction unit may be performed using AI or without using AI. For example, the correction unit can input information from related literature into AI and perform correction using an AI model that improves correction accuracy. Specifically, the correction unit receives, as input, text data from related literature (e.g., paper PDFs, patent specifications, technical blog articles), algorithm descriptions, and parameter recommendation lists as structured or unstructured data. The correction unit vectorizes these literature data using natural language processing models (e.g., BERT, LLM), and performs technical keyword extraction, algorithm structure analysis, and parameter candidate list generation. The AI model outputs correction criteria (e.g., position correction threshold, color correction coefficient), algorithm selection (e.g., Kalman filter, subpixel interpolation, RANSAC), and parameter optimization (e.g., smoothing coefficient, outlier threshold) based on the extracted knowledge base. Examples of AI model input/output include: input: latest image correction paper →output: recommended algorithm “Kalman filter,” threshold 0.88; or input: patent specification→output: recommended feature weighting “color+shape.” The correction unit automatically updates correction algorithms and parameters based on the output optimization results and executes re-correction. As a subsequent process, the correction unit passes optimized correction results to the learning unit or automatic execution module of the RPA scenario, and builds a continuous algorithm improvement cycle. As a technical effect, the correction unit greatly improves correction accuracy, versatility, and adaptability by dynamically incorporating the latest technical knowledge and external knowledge. Application fields include continual learning image correction, medical image diagnosis support, manufacturing inspection AI, and personalized UI automation. These processes, unlike conventional static algorithm selection or manual parameter adjustment, realize autonomous and continuous correction algorithm optimization by computers, leading to the evolution and improvement of image correction technology itself.

The preprocessing unit can estimate a user's emotion and adjust the preprocessing method based on the estimated emotion of the user. For example, the preprocessing unit can apply a strict preprocessing method when the user is focused. Additionally, the preprocessing unit can apply a simple preprocessing method when the user is fatigued. Furthermore, the preprocessing unit can apply a preprocessing method tailored to the user's pace when the user is relaxed. By adjusting the preprocessing method based on the user's emotion, the preprocessing unit enables efficient preprocessing. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the preprocessing unit may be performed using generative AI or without using generative AI. For example, the preprocessing unit can use generative AI to estimate the user's emotion and adjust the preprocessing method based on the estimated emotion to perform preprocessing. Specifically, the preprocessing unit receives, as input, various time-series data such as facial expression images (e.g., facial image tensor 128×128 pixels), audio waveform data (e.g., 1-second 16 kHz sample), operation logs (e.g., click frequency, mouse movement speed), and biometric sensor data (e.g., heart rate, skin conductance). The preprocessing unit preprocesses these data to generate facial feature vectors (e.g., 68 facial landmarks), voice emotion features (e.g., MFCC, pitch), and operation pattern vectors (e.g., 10 dimensions). The generative AI model (e.g., Transformer-based multimodal model) takes these feature vectors as input and outputs emotion labels (e.g., “focused,” “fatigued,” “relaxed”) and emotion scores (e.g., focused 0.85, fatigued 0.10, relaxed 0.05). Examples of AI model output include: input: facial image +click frequency→output: emotion “focused,” score 0.92; or input: voice+heart rate→output: emotion “fatigued,” score 0.80. The preprocessing unit dynamically changes preprocessing algorithm selection and parameter settings according to the estimated emotion. For example, in a “focused” state, high-precision preprocessing such as noise removal, contrast correction, and normalization is applied, and thresholds and filter sizes are strictly set. In a “fatigued” state, simple preprocessing with low computational load (e.g., resizing only, simple histogram equalization) is selected to reduce user burden. In a “relaxed” state, individually optimized preprocessing parameters are applied based on the user's past preprocessing history and operation tendencies. Examples of AI model input/output include: input: image tensor+emotion “focused”→output: noise removal strength 0.9, contrast correction coefficient 1.2; or input: image tensor+emotion “fatigued”→output: resizing only applied. As a subsequent process, the preprocessing unit passes preprocessed image data to the learning unit or matching unit, and if the confidence is below the threshold, instructs re-preprocessing or additional data collection. As a technical effect, the preprocessing unit greatly improves preprocessing accuracy, computational efficiency, and user adaptability through dynamic preprocessing method control according to the user's state. Application fields include personalized UI automation, educational support AI, medical image diagnosis support, and user state-adaptive RPA scenario generation. These processes, unlike subjective human judgment or manual preprocessing method selection, realize multivariate data analysis and autonomous preprocessing control by computers, leading to the evolution and improvement of image preprocessing technology itself.

The preprocessing unit can evaluate the quality of image data during preprocessing and automatically exclude data determined to be of low quality. For example, the preprocessing unit can evaluate the resolution of image data and exclude low-resolution data. Additionally, the preprocessing unit can evaluate the brightness and contrast of image data and exclude inappropriate data. Furthermore, the preprocessing unit can evaluate the noise level of image data and exclude data with high noise. By evaluating the quality of image data and excluding low-quality data, the preprocessing unit can improve the quality of preprocessing. Some or all of the above-described processes in the preprocessing unit may be performed using AI or without using AI. For example, the preprocessing unit can input the quality of image data into AI and perform preprocessing using an AI model that automatically excludes low-quality data. Specifically, the preprocessing unit receives, as input, image tensors immediately after collection (e.g., 3-channel RGB, 224×224 pixels), and sequentially applies resolution determination algorithms (e.g., threshold judgment of image size), brightness/contrast evaluation algorithms (e.g., mean luminance value, standard deviation, histogram distribution), and noise level estimation algorithms (e.g., spatial frequency analysis, local variance calculation). The preprocessing unit summarizes these evaluation values as a quality feature vector (e.g., resolution value, mean luminance, contrast value, noise score: 4-dimensional vector) and inputs it into an AI model (e.g., convolutional neural network or fully connected network for quality judgment). The AI model outputs quality labels (e.g., “high quality,” “low quality”) and quality scores (e.g., 0.92) based on the input quality feature vector. Specific examples of AI model input/output include: input: dark 224×224 pixel image→output: quality score 0.45 (low quality); input: noisy image→output: quality score 0.38 (low quality); input: image with appropriate brightness and contrast→output: quality score 0.95 (high quality). The preprocessing unit automatically excludes image data if the AI model output is below a predetermined threshold (e.g., 0.80), and passes only data above the threshold to subsequent processing. As a subsequent process, the preprocessing unit records metadata of excluded images (e.g., exclusion reason, acquisition time, device information) and saves it as a quality management log. As a technical effect, the preprocessing unit achieves real-time and automatic quality evaluation and exclusion processing, thereby homogenizing the quality of the preprocessing dataset and preventing noise contamination, greatly improving the accuracy, stability, and convergence of subsequent AI learning and image recognition processing. Application fields include preprocessing of medical image diagnosis data, preprocessing of appearance inspection data on manufacturing lines, quality management of surveillance camera images, and preprocessing of images for UI automation. These processes, unlike manual quality judgment or exclusion by human visual inspection, realize autonomous and consistent quality management in high-dimensional feature space by computers, leading to the evolution and improvement of image preprocessing technology itself.

The preprocessing unit can estimate a user's emotion and determine the priority of preprocessing based on the estimated emotion of the user. For example, the preprocessing unit can prioritize important preprocessing when the user is focused. Additionally, the preprocessing unit can prioritize simple preprocessing when the user is fatigued. Furthermore, the preprocessing unit can prioritize preprocessing tailored to the user's pace when the user is relaxed. By determining the priority of preprocessing based on the user's emotion, the preprocessing unit enables efficient preprocessing. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the preprocessing unit may be performed using generative AI or without using generative AI. For example, the preprocessing unit can use generative AI to estimate the user's emotion and determine the priority of preprocessing based on the estimated emotion to perform preprocessing. Specifically, the preprocessing unit receives, as input, various time-series data such as facial expression images (e.g., facial image tensor 128×128 pixels), audio waveform data (e.g., 1-second 16 kHz sample), operation logs (e.g., click frequency, mouse movement speed), and biometric sensor data (e.g., heart rate, skin conductance). The preprocessing unit preprocesses these data to generate facial feature vectors (e.g., 68 facial landmarks), voice emotion features (e.g., MFCC, pitch), and operation pattern vectors (e.g., 10 dimensions). The generative AI model (e.g., Transformer-based multimodal model) takes these feature vectors as input and outputs emotion labels (e.g., “focused,” “fatigued,” “relaxed”) and emotion scores (e.g., focused 0.85, fatigued 0.10, relaxed 0.05). Examples of AI model output include: input: facial image+click frequency→output: emotion “focused,” score 0.92; or input: voice+heart rate→output: emotion “fatigued,” score 0.80. The preprocessing unit generates a preprocessing target list (e.g., important objects, simple objects, objects of interest) according to the estimated emotion and instructs the preprocessing scheduler. For example, in a “focused” state, preprocessing of essential buttons or icons for business is prioritized; in a “fatigued” state, preprocessing of objects with clear contours or high contrast is prioritized; in a “relaxed” state, preprocessing based on the user's past interest history or custom tags is prioritized. As a subsequent process, the preprocessing unit applies preprocessing algorithms according to priority and passes preprocessing results to the learning unit or matching unit. As a technical effect, the preprocessing unit achieves flexible preprocessing priority control according to the user's state, efficiently realizing high-quality preprocessing at necessary timing while preventing unnecessary preprocessing and increased user burden. Application fields include human interface optimization, personalized RPA scenario generation, user state monitoring in medical and welfare fields, and educational support systems. These processes, unlike subjective human judgment or manual priority setting, realize multivariate data analysis and autonomous preprocessing control by computers, leading to the evolution and improvement of image preprocessing technology itself.

The preprocessing unit can integrate image data collected from different devices during preprocessing. For example, the preprocessing unit can integrate image data collected from a smartphone and image data collected from a tablet for preprocessing. Additionally, the preprocessing unit can integrate image data collected from a digital camera and image data collected from a webcam for preprocessing. Furthermore, the preprocessing unit can integrate image data collected from a drone and image data collected from a fixed camera for preprocessing. By integrating image data collected from different devices during preprocessing, the preprocessing unit can improve preprocessing accuracy. Some or all of the above-described processes in the preprocessing unit may be performed using AI or without using AI. For example, the preprocessing unit can input image data collected from different devices into AI and perform preprocessing using an AI model that integrates such data. Specifically, the preprocessing unit receives, as input, image tensors for each device type (e.g., smartphone: 224×224 pixels, tablet: 512×512 pixels, digital camera: 1024×1024 pixels, drone: 640×480 pixels) and metadata (e.g., device ID, shooting conditions, resolution information). The preprocessing unit performs resizing, normalization, color space conversion, etc., in the preprocessing unit, and extracts feature vectors (e.g., 512 dimensions) for each device type. The preprocessing unit uses architectures such as multi-domain preprocessing networks, domain adaptation layers in CNNs, or Vision Transformers to integratively preprocess image features originating from different devices. Examples of AI model input/output include: input: smartphone image+device ID→output: noise-removed image; or input: drone image+shooting altitude→output: color-corrected image. The preprocessing unit applies domain adaptation loss or adversarial learning to reduce distribution differences between devices and improve overall preprocessing accuracy. As a subsequent process, the preprocessing unit deploys preprocessed images to the learning unit or matching unit, thereby enabling highly accurate preprocessing for diverse device images during actual operation. As a technical effect, the preprocessing unit enables the construction of general-purpose preprocessing technology with low device dependency by integrative preprocessing of heterogeneous device images, achieving significant improvements in accuracy and stability compared to conventional single-device-dependent preprocessing. Application fields include UI automation, manufacturing inspection, surveillance camera image analysis, and medical image diagnosis. These processes, unlike manual data integration or single-device preprocessing by humans, realize automatic and comprehensive data integration and preprocessing control by computers, leading to the evolution and improvement of image preprocessing technology itself.

The hardware management unit can estimate a user's emotion and adjust hardware usage based on the estimated emotion of the user. For example, the hardware management unit can optimize hardware usage for efficient processing when the user is focused. Additionally, the hardware management unit can adjust hardware usage to reduce load when the user is fatigued. Furthermore, the hardware management unit can adjust hardware usage to match the user's pace when the user is relaxed. By adjusting hardware usage based on the user's emotion, the hardware management unit enables efficient hardware management. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the hardware management unit may be performed using generative AI or without using generative AI. For example, the hardware management unit can use generative AI to estimate the user's emotion and adjust hardware usage based on the estimated emotion to perform hardware management. Specifically, the hardware management unit receives, as input, various time-series data such as facial expression images (e.g., facial image tensor 128×128 pixels), audio waveform data (e.g., 1-second 16 kHz sample), operation logs (e.g., keyboard input frequency, mouse movement speed), and biometric sensor data (e.g., heart rate, skin conductance). The hardware management unit preprocesses these data to generate facial feature vectors (e.g., 68 facial landmarks), voice emotion features (e.g., MFCC, pitch), and operation pattern vectors (e.g., 10 dimensions). The hardware management unit inputs these feature vectors into a generative AI model (e.g., Transformer-based multimodal model), which outputs emotion labels (e.g., “focused,” “fatigued,” “relaxed”) and emotion scores (e.g., focused 0.85, fatigued 0.10, relaxed 0.05). Examples of AI model output include: input: facial image+keyboard input frequency→output: emotion “focused,” score 0.92; or input: voice+heart rate→output: emotion “fatigued,” score 0.80. The hardware management unit dynamically adjusts hardware resource control parameters such as CPU core allocation, GPU usage rate, memory bandwidth, and I/O priority according to the estimated emotion. For example, in a “focused” state, GPU-based parallel computation cluster resources are maximized, and batch processing or fast inference is prioritized. In a “fatigued” state, CPU clock down or power-saving mode is applied, and fan speed or heat generation is suppressed. In a “relaxed” state, resource allocation is individually optimized according to the user's past usage tendencies and work pace. Examples of AI model input/output include: input: emotion “focused”→output: GPU usage rate 90%, 8 CPU cores allocated; or input: emotion “fatigued”→output: GPU usage rate 30%, power-saving mode ON. The hardware management unit instructs the OS resource manager or virtualization platform to change hardware configuration in real time according to resource control results. As a subsequent process, the hardware management unit records resource usage history and performance indicators for each emotional state (e.g., processing delay, power consumption, temperature trends), and utilizes them for future resource optimization strategies. As a technical effect, the hardware management unit greatly improves processing efficiency, power consumption, and user experience through dynamic hardware resource control according to the user's state. Application fields include personalized UI automation, educational support AI, medical image diagnosis support, user state-adaptive RPA scenario generation, and cloud resource optimization. These processes, unlike subjective human judgment or manual resource allocation, realize multivariate data analysis and autonomous hardware control by computers, leading to the evolution and improvement of hardware management technology itself.

The hardware management unit can select an optimal hardware configuration by referring to past usage history during hardware management. For example, the hardware management unit can select the optimal hardware configuration based on past usage history. Additionally, the hardware management unit can analyze errors in past usage history to identify areas for improvement in hardware configuration. Furthermore, the hardware management unit can adjust hardware configuration parameters based on successful cases in past usage history. By selecting the optimal hardware configuration by referring to past usage history, the hardware management unit can improve hardware management accuracy. Some or all of the above-described processes in the hardware management unit may be performed using AI or without using AI. For example, the hardware management unit can input past usage history into AI and perform hardware management using an AI model that selects the optimal hardware configuration. Specifically, the hardware management unit receives, as input, past hardware usage history data (e.g., time-series CPU usage rate, GPU usage rate, memory consumption, I/O wait time, power consumption, temperature trends, error occurrence time, configuration parameters, processing success rate as structured data). The hardware management unit extracts performance indicators (e.g., average CPU load, peak GPU usage rate, error occurrence frequency, power consumption trends) and error distributions (e.g., configuration during resource exhaustion, parameters during temperature anomaly occurrence) from these history data. The hardware management unit inputs these feature vectors into an AI model (e.g., meta-learning network or hyperparameter optimization algorithm), which outputs optimal hardware configuration selection (e.g., number of CPU cores, number of GPU clusters, memory allocation, I/O priority), parameter settings (e.g., clock frequency, fan control threshold), and areas for improvement (e.g., cooling enhancement recommendation, addition of redundant configuration). Examples of AI model output include: input: past 10 high-load processing histories→output: optimal configuration “CPU 8 cores+2 GPUs,” fan speed 3000 rpm; or input: history during frequent errors→output: memory expansion recommendation, clock down setting. The hardware management unit automatically updates hardware configuration and parameters based on the output optimization results and executes configuration changes in real time. As a subsequent process, the hardware management unit records optimized performance indicators and error occurrence rates, and builds a continuous configuration improvement cycle. As a technical effect, the hardware management unit greatly improves processing efficiency, stability, and fault tolerance through dynamic configuration optimization utilizing past usage history. Application fields include cloud resource optimization, automatic control of manufacturing lines, medical image diagnosis support, and personalized UI automation. These processes, unlike conventional static configuration selection or manual parameter adjustment, realize autonomous and continuous hardware configuration optimization by computers, leading to the evolution and improvement of hardware management technology itself.

The hardware management unit can estimate a user's emotion and determine the priority of hardware usage based on the estimated emotion of the user. For example, the hardware management unit can prioritize the use of important hardware when the user is focused. Additionally, the hardware management unit can prioritize the use of low-load hardware when the user is fatigued. Furthermore, the hardware management unit can prioritize hardware usage tailored to the user's pace when the user is relaxed. By determining the priority of hardware usage based on the user's emotion, the hardware management unit enables efficient hardware management. Emotion estimation may be implemented using, for example, an emotion engine or generative AI with emotion estimation functionality. Generative AI may include text generation AI (e.g., LLM) or multimodal generative AI, but is not limited to these examples. Some or all of the above-described processes in the hardware management unit may be performed using generative AI or without using generative AI. For example, the hardware management unit can use generative AI to estimate the user's emotion and determine the priority of hardware usage based on the estimated emotion to perform hardware management. Specifically, the hardware management unit receives, as input, various time-series data such as facial expression images (e.g., facial image tensor 128×128 pixels), audio waveform data (e.g., 1-second 16 kHz sample), operation logs (e.g., keyboard input frequency, mouse movement speed), and biometric sensor data (e.g., heart rate, skin conductance). The hardware management unit preprocesses these data to generate facial feature vectors (e.g., 68 facial landmarks), voice emotion features (e.g., MFCC, pitch), and operation pattern vectors (e.g., 10 dimensions). The hardware management unit inputs these feature vectors into a generative AI model (e.g., Transformer-based multimodal model), which outputs emotion labels (e.g., “focused,” “fatigued,” “relaxed”) and emotion scores (e.g., focused 0.85, fatigued 0.10, relaxed 0.05). Examples of AI model output include: input: facial image +keyboard input frequency→output: emotion “focused,” score 0.92; or input: voice+heart rate→output: emotion “fatigued,” score 0.80. The hardware management unit generates a hardware resource priority list (e.g., GPU, CPU, FPGA, TPU, storage I/O) according to the estimated emotion and instructs the resource scheduler. For example, in a “focused” state, priority use of GPU and high-speed storage is instructed to accelerate batch processing and inference tasks; in a “fatigued” state, priority use of low-power CPUs and power-saving storage is instructed to suppress heat generation and noise; in a “relaxed” state, resource allocation is individually optimized according to the user's past usage tendencies and work pace. Examples of AI model input/output include: input: emotion “focused”→output: GPU priority 1st, CPU 2nd; or input: emotion “fatigued”→output: low-power CPU priority 1st. The hardware management unit instructs the OS or virtualization platform to allocate resources according to priority and controls hardware usage order in real time. As a subsequent process, the hardware management unit records priority control results and performance indicators (e.g., processing delay, power consumption, user satisfaction), and utilizes them for future resource optimization strategies. As a technical effect, the hardware management unit greatly improves processing efficiency, power consumption, and user experience through dynamic resource priority control according to the user's state. Application fields include personalized UI automation, educational support AI, medical image diagnosis support, user state-adaptive RPA scenario generation, and cloud resource optimization. These processes, unlike subjective human judgment or manual priority setting, realize multivariate data analysis and autonomous hardware priority control by computers, leading to the evolution and improvement of hardware management technology itself.

The hardware management unit can integrate and manage the usage status of different devices during hardware management. For example, the hardware management unit can integrate and manage the usage status of smartphones and tablets. Additionally, the hardware management unit can integrate and manage the usage status of digital cameras and webcams. Furthermore, the hardware management unit can integrate and manage the usage status of drones and fixed cameras. By integrating and managing the usage status of different devices, the hardware management unit can improve the efficiency of hardware management. Some or all of the above-described processes in the hardware management unit may be performed using AI or without using AI. For example, the hardware management unit can input the usage status of different devices into AI and perform hardware management using an AI model that integrates and manages the devices. Specifically, the hardware management unit receives as input usage status data for each device type (e.g., smartphone CPU usage rate, tablet memory consumption, digital camera operating time, drone battery level, fixed camera I/O bandwidth, structured data such as operation logs and error histories for each device). The hardware management unit applies normalization, time-series alignment, and outlier removal in the preprocessing unit to these data and extracts feature vectors (e.g., 10 dimensions) for each device type. The hardware management unit inputs these feature vectors into an AI model with a multi-domain management network or domain adaptation layer (e.g., CNN, RNN, Transformer), and outputs globally optimized resource allocation (e.g., device operation priority, load balancing parameters, battery consumption optimization instructions). Examples of AI model input/output include: input: smartphone CPU usage rate 80%, tablet memory consumption 2GB→output: smartphone load balancing recommendation, tablet priority increase; or input: drone battery level 20%, fixed camera I/O bandwidth 90%→output: drone power-saving mode, fixed camera data compression recommendation. The hardware management unit issues instructions to resource control APIs or OSs for each device based on the output integrated management results, optimizing operation status in real time. As a subsequent process, the hardware management unit records integrated management history and performance indicators (e.g., total power consumption, operation rate, failure rate) and utilizes them for future resource optimization strategies. As a technical effect, the hardware management unit greatly improves system-wide efficiency, stability, and fault tolerance through integrated management of heterogeneous devices. Application fields include IoT device integrated management, automated control of manufacturing lines, surveillance camera image analysis, integrated management of medical devices, and personalized UI automation. These processes differ from manual device management or single-device-dependent management, realizing automatic and comprehensive data integration and resource control by computer, and bringing about evolution and improvement of hardware management technology itself.

The system according to the embodiment is not limited to the above examples and can be variously modified as described below. Specifically, the system allows for diverse variations in AI model architecture and learning methods, data flow, hardware configuration, user interface, application fields, and more. The system may adopt a hybrid configuration that links multiple AI models (e.g., CNN for image recognition, RNN for time-series analysis, Transformer for natural language processing), not just a single neural network. The system can operate on various hardware resources such as cloud-based GPU clusters, edge devices, FPGA, TPU, and supports advanced learning methods such as distributed learning, federated learning, and online learning. The system accepts not only image data but also diverse multimodal inputs such as audio, text, sensor data, and time-series data, and can dynamically exchange features and intermediate representations between modules. The system can combine multiple AI functions such as user emotion estimation, behavior analysis, geographic information analysis, anomaly detection, and personalized recommendation to achieve advanced autonomous control. Application fields include automatic inspection in manufacturing, medical image diagnosis support, surveillance camera image analysis, educational support AI, personalized UI automation, robotics, smart cities, IoT device integrated management, and more, covering a wide range of industries and social infrastructure. Through these diverse configurations and implementation variations, the system, unlike conventional static and single-function systems, promotes the evolution and expansion of computer technology itself and demonstrates high flexibility, scalability, and adaptability as a future AI application platform.

The collection unit can analyze the user's operation history and preferentially collect image data of frequently used objects. For example, if the user frequently clicks a particular button, the collection unit intensively collects image data of that button. Additionally, the collection unit can newly collect image data of objects that the user has never operated before. Furthermore, the collection unit can collect image data of objects used during specific time periods based on the user's operation history. By dynamically changing the types of image data to be collected based on the user's operation history, the collection unit can efficiently collect necessary data. Specifically, the collection unit receives as input the user's operation log data (e.g., time-series of click events, button IDs, operation times, window transition history, list of unoperated objects as structured data). The collection unit converts these data into operation frequency vectors (e.g., number of clicks per object, time-of-day operation histograms), new operation candidate lists (e.g., unoperated object IDs), and time-of-day feature vectors (e.g., 24-dimensional time-of-day operation frequency), and inputs them into an AI model (e.g., RNN for operation history analysis or recommendation network). The AI model outputs an object list with collection priorities based on the input feature vectors (e.g., frequently operated objects: 0.95, new objects: 0.88, objects for specific time periods: 0.90). Examples of AI model output include: input: click history for the past month→output: button A priority 0.93; input: list of unoperated objects→output: object B priority 0.89. The collection unit issues collection instructions to the image capture API based on the output priorities and stores the data in the collection database. As a subsequent process, the collection unit links and records operation history and collection history, utilizing them for future personalized AI model learning and UI optimization. As a technical effect, the collection unit realizes dynamic data collection tailored to the user's operation tendencies, improving the personalization and adaptability of learning models. Application fields include personalized UI automation, user behavior analysis, ad recommendation, and individualized systems in education and healthcare. These processes differ from conventional static data collection and manual operation judgment, realizing multivariate data analysis and autonomous collection control by computer, and bringing about evolution and improvement of image data collection technology itself.

The preprocessing unit can evaluate the quality of collected image data in real time and automatically exclude data determined to be of low quality. For example, the preprocessing unit evaluates the resolution of collected image data in real time and excludes low-resolution data. The preprocessing unit can also evaluate the brightness and contrast of collected image data and exclude inappropriate data. Furthermore, the preprocessing unit can evaluate the noise level of collected image data and exclude data with high noise. By evaluating the quality of image data in real time and excluding low-quality data, the preprocessing unit can maintain data quality. Specifically, the preprocessing unit receives as input image tensors immediately after collection (e.g., 3-channel RGB, 224×224 pixels), and sequentially applies resolution determination algorithms (e.g., threshold judgment of image size), brightness/contrast evaluation algorithms (e.g., average luminance value, standard deviation, histogram distribution), and noise level estimation algorithms (e.g., spatial frequency analysis, local variance calculation). The preprocessing unit summarizes these evaluation values as a quality feature vector (e.g., a 4-dimensional vector of resolution value, average luminance, contrast value, noise score) and inputs it into an AI model (e.g., convolutional neural network or fully connected network for quality judgment). The AI model outputs a quality label (e.g., “high quality”, “low quality”) or quality score (e.g., 0.92) based on the input quality feature vector. Examples of AI model input/output include: input: dark image of 224×224 pixels→output: quality score 0.45 (low quality); input: noisy image→output: quality score 0.38 (low quality); input: image with appropriate brightness and contrast →output: quality score 0.95 (high quality). The preprocessing unit automatically excludes image data if the AI model output is below a predetermined threshold (e.g., 0.80), and passes only data above the threshold to subsequent processing. As a subsequent process, the preprocessing unit records metadata of excluded images (e.g., exclusion reason, acquisition time, device information) and saves it as a quality management log. As a technical effect, the preprocessing unit realizes uniform quality and noise prevention in the preprocessing dataset through real-time and automatic quality evaluation and exclusion, greatly improving the accuracy, stability, and convergence of subsequent AI learning and image recognition processing. Application fields include preprocessing of medical image diagnostic data, preprocessing of appearance inspection data in manufacturing lines, quality management of surveillance camera footage, and preprocessing of images for UI automation. These processes differ from manual quality judgment and exclusion by human visual inspection, realizing autonomous and consistent quality management in high-dimensional feature space by computer, and bringing about evolution and improvement of image preprocessing technology itself.

The hardware management unit can optimally allocate hardware resources used for learning. For example, the hardware management unit monitors the usage status of hardware during learning in real time and performs efficient hardware management. The hardware management unit can dynamically adjust hardware resources used for learning to improve learning efficiency. Furthermore, by optimizing hardware resources used for learning, the hardware management unit can improve learning performance. By managing hardware used for learning, the hardware management unit can improve learning efficiency. Specifically, the hardware management unit receives as input learning job information (e.g., batch size, number of epochs, number of model parameters), hardware resource status (e.g., GPU usage rate, CPU load, memory consumption, I/O bandwidth, power consumption, temperature trends), and past learning performance history (e.g., learning time, loss value trends, accuracy trends). The hardware management unit converts these data into feature vectors (e.g., 20 dimensions) and inputs them into an AI model (e.g., reinforcement learning network for resource optimization or hyperparameter optimization algorithm). The AI model outputs optimal resource allocation (e.g., number of GPU clusters, number of CPU cores, memory allocation, I/O priority), parameter settings (e.g., batch size, learning rate), and resource reallocation instructions based on the input feature vectors. Examples of AI model output include: input: learning job A+GPU usage rate 80%→output: assign 2 GPUs, batch size 128; or input: learning job B+high CPU load→output: recommend increasing CPU cores. The hardware management unit issues instructions to resource control APIs or virtualization platforms based on the output optimization results and changes hardware configuration in real time. As a subsequent process, the hardware management unit records resource allocation history and learning performance indicators (e.g., learning time reduction rate, power consumption reduction rate, accuracy improvement rate) and builds a continuous resource optimization cycle. As a technical effect, the hardware management unit greatly improves learning efficiency, performance, power consumption, and cost efficiency through dynamic resource optimization according to learning job characteristics and hardware status. Application fields include cloud AI learning platforms, manufacturing inspection AI, medical image diagnosis support, and personalized UI automation. These processes differ from conventional static resource allocation and manual configuration adjustment, realizing autonomous and continuous hardware resource optimization by computer, and bringing about evolution and improvement of AI learning platform technology itself.

The collection unit can preferentially collect highly relevant image data based on the user's geographic location information. For example, if the user is in a specific region, the collection unit preferentially collects image data of objects related to that region. Additionally, if the user is moving, the collection unit can collect image data of objects related to the destination. Furthermore, if the user is inside a specific facility, the collection unit can preferentially collect image data of objects within that facility. By preferentially collecting highly relevant image data based on the user's geographic location information, the collection unit enables efficient data collection. Specifically, the collection unit receives as input GPS coordinate data (e.g., 2-dimensional vector of latitude and longitude), Wi-Fi/Bluetooth beacon information, facility ID, and time-series movement history data. The collection unit converts these location data into geographic feature vectors (e.g., current location, movement speed, duration of stay, facility type) and inputs them into an AI model (e.g., fully connected network for geographic relevance estimation or time-series RNN). The AI model outputs an object list with relevance scores based on the input geographic feature vectors (e.g., button in region A: 0.95, icon in facility B: 0.88). Examples of AI model output include: input: latitude 35.6, longitude 139.7→output: region A related object priority 0.93; input: destination facility ID 123→output: facility B related object priority 0.90. The collection unit issues collection instructions to the image capture API based on the output priorities and stores the data in the collection database. As a subsequent process, the collection unit records collection history and geographic metadata and utilizes them for future collection strategy optimization. As a technical effect, the collection unit realizes dynamic data collection according to the user's geographic situation, enabling the construction of region-specific AI models and improving on-site adaptability. Application fields include location-linked UI automation, on-site work support, region-specific manufacturing inspection, and tourist information systems. These processes differ from conventional static data collection and manual region judgment, realizing geographic information analysis and autonomous collection control by computer, and bringing about evolution and improvement of image data collection technology itself.

The learning unit can improve the versatility of the model by combining image data of different resolutions and angles during learning. For example, the learning unit combines image data of different resolutions during learning to reduce the model's dependency on resolution. The learning unit can also combine image data taken from different angles during learning to reduce the model's dependency on angle. Furthermore, the learning unit can combine image data taken under different environmental conditions during learning to reduce the model's dependency on environment. By combining image data of different resolutions and angles during learning, the learning unit can improve the versatility of the model. Specifically, the learning unit receives as input image tensors acquired at various resolutions (e.g., 224×224, 512×512, 1024×1024 pixels), various angles (e.g., 0°, 30°, 60°, 90°), and different environmental conditions (e.g., day/night, lighting changes, background differences). The learning unit applies normalization, resizing, contrast correction, etc., in the preprocessing unit to these image data and integrates them as a learning dataset. The learning unit uses architectures such as convolutional neural networks (CNN), Vision Transformer, and multi-scale networks to extract feature vectors (e.g., 512 dimensions) from input images and output classification labels or bounding box coordinates. When using generative AI, the learning unit automatically generates variation images of new resolutions, angles, and environmental conditions from input images for data augmentation. Examples of AI model input/output include: input: button image of 224×224 pixels+90° rotation→output: class label “button”, score 0.93; or input: icon image in low-light environment→output: bounding box (x=100, y=50, w=40, h=20), confidence 0.90. The learning unit mixes images of different resolutions, angles, and environmental conditions in batches and applies mini-batch normalization and domain adaptation layers to enhance the versatility and robustness of the model. As a subsequent process, the learning unit deploys the trained model to the matching unit and correction unit, enabling highly accurate recognition and correction for diverse input images in actual operation. As a technical effect, the learning unit maximizes the use of image data diversity to build a general-purpose AI model robust to resolution, angle, and environmental changes, achieving significant improvements in accuracy and stability compared to conventional single-condition-dependent models. Application fields include UI automation, manufacturing inspection, surveillance camera image analysis, and medical image diagnosis. These processes differ from manual data augmentation and single-condition learning by humans, realizing automatic and comprehensive data integration and learning control by computer, and bringing about evolution and improvement of AI learning technology itself.

The collection unit can estimate a user's emotion and adjust the timing of image data collection based on the estimated emotion of the user. For example, when the user is focused, the collection timing is shortened to efficiently collect data. When the user is fatigued, the collection timing is lengthened to collect data while allowing for breaks. Furthermore, when the user is relaxed, the collection timing can be adjusted to match the user's pace. By adjusting the timing of image data collection based on the user's emotion, the collection unit enables efficient data collection. Specifically, the collection unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The collection unit preprocesses these data to generate face feature vectors (e.g., 68 facial landmarks), audio emotion features (e.g., MFCC, pitch), and operation pattern vectors (e.g., 10 dimensions). The collection unit inputs these feature vectors into a generative AI model (e.g., Transformer-based multimodal model), which outputs emotion labels (e.g., “focused”, “fatigued”, “relaxed”) and emotion scores (e.g., focused 0.85, fatigued 0.10, relaxed 0.05). Examples of AI model output include: input: face image+click frequency→output: emotion “focused”, score 0.92; or input: audio+heart rate→output: emotion “fatigued”, score 0.80. The collection unit dynamically adjusts collection timing control parameters (e.g., collection intervals of 1 minute, 5 minutes, 10 minutes) according to the estimated emotion, performing high-frequency collection in the “focused” state, low-frequency collection in the “fatigued” state, and pace adjustment based on the user's past collection history in the “relaxed” state. As a subsequent process, the collection unit records collection timing history and collection efficiency indicators for each emotion state (e.g., number of collections, data quality, user load) and utilizes them for future collection strategy optimization. As a technical effect, the collection unit greatly improves data collection efficiency, quality, and user adaptability through dynamic collection timing control according to the user's state. Application fields include personalized UI automation, educational support AI, medical image diagnosis support, and user state-adaptive RPA scenario generation. These processes differ from subjective human judgment and manual timing adjustment, realizing multivariate data analysis and autonomous collection timing control by computer, and bringing about evolution and improvement of image data collection technology itself.

The learning unit can estimate a user's emotion and select learning data based on the estimated emotion of the user. For example, when the user is focused, the learning unit can select high-difficulty learning data. When the user is fatigued, the learning unit can select easy learning data. Furthermore, when the user is relaxed, the learning unit can select learning data tailored to the user's interests. By selecting learning data based on the user's emotion, the learning unit enables efficient learning. Specifically, the learning unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The learning unit preprocesses these data to generate face feature vectors (e.g., 68 facial landmarks), audio emotion features (e.g., MFCC, pitch), and operation pattern vectors (e.g., 10 dimensions). The learning unit inputs these feature vectors into a generative AI model (e.g., Transformer-based multimodal model), which outputs emotion labels (e.g., “focused”, “fatigued”, “relaxed”) and emotion scores (e.g., focused 0.85, fatigued 0.10, relaxed 0.05). Examples of AI model output include: input: face image+click frequency→output: emotion “focused”, score 0.92; or input: audio+heart rate→output: emotion “fatigued”, score 0.80. According to the estimated emotion, the learning unit selects image datasets with difficulty labels or interest tags from the learning database, preferentially extracting high-difficulty images (e.g., complex UI components or hard-to-distinguish icon images) in the “focused” state, simple images (e.g., clear contours or high-contrast button images) in the “fatigued” state, and images based on the user's past interest history (e.g., icons of specific categories) in the “relaxed” state. The learning unit inputs the selected image data into learning algorithms (e.g., CNN, Vision Transformer, SVM) and performs learning processes such as feature extraction, classification, and regression. Examples of AI model input/output include: input: high-difficulty button image→output: class label “button”, bounding box (x=120, y=80, w=40, h=20), confidence 0.95; or input: icon image with interest tag→output: class label “icon”, score 0.90. As a subsequent process, the learning unit records learning progress and accuracy evaluation indicators (e.g., loss value, accuracy, recall) and analyzes learning effects for each emotion state. As a technical effect, the learning unit greatly improves learning efficiency, model accuracy, and user adaptability through dynamic learning data selection according to the user's state. Application fields include personalized UI automation, educational support AI, medical image diagnosis support, and user state-adaptive RPA scenario generation. These processes differ from subjective human judgment and manual data selection, realizing multivariate data analysis and autonomous learning control by computer, and bringing about evolution and improvement of learning data selection technology itself.

The matching unit can estimate a user's emotion and adjust matching criteria based on the estimated emotion of the user. For example, when the user is focused, strict matching criteria can be applied. When the user is fatigued, relaxed matching criteria can be applied. Furthermore, when the user is relaxed, matching criteria tailored to the user's pace can be applied. By adjusting matching criteria based on the user's emotion, the matching unit enables efficient matching. Specifically, the matching unit receives as input feature vectors indicating the user's emotional state (e.g., face image tensor 128×128 pixels, 1-second 16 kHz audio waveform data, 10-dimensional operation log vector, biometric sensor data such as heart rate and skin conductance). The matching unit preprocesses these diverse time-series data to generate face feature vectors (e.g., 68 facial landmarks), audio emotion features (e.g., MFCC, pitch), and operation pattern vectors. A generative AI model (e.g., Transformer-based multimodal model) inputs these feature vectors and outputs emotion labels (e.g., “focused”, “fatigued”, “relaxed”) and emotion scores (e.g., focused 0.85, fatigued 0.10, relaxed 0.05). Examples of AI model output include: input: face image+click frequency→output: emotion “focused”, score 0.92; or input: audio+heart rate→output: emotion “fatigued”, score 0.80. According to the estimated emotion, the matching unit dynamically adjusts thresholds and allowable error parameters in image matching processing. For example, in the “focused” state, the cosine similarity threshold is set to 0.90 or higher, and strict matching is performed to eliminate false detections as much as possible. In the “fatigued” state, the threshold is relaxed to around 0.80, allowing some errors to increase the matching success rate. In the “relaxed” state, individually optimized criteria are applied based on the user's past operation history and objects of interest. Examples of AI model input/output include: input: 224×224 pixel button image +emotion “focused”→output: bounding box (x=120, y=80, w=40, h=20), confidence 0.95 (strict criteria); or input: same image+emotion “fatigued”→output: bounding box (x=122, y=82, w=40, h=20), confidence 0.85 (relaxed criteria). As a subsequent process, the matching unit passes the output position information and confidence to the correction unit, and if the confidence is below the threshold, instructs re-matching or additional data collection. As a technical effect, the matching unit achieves both reduction of false detection rate and optimization of user load through dynamic matching criteria control according to the user's state, greatly improving the automation accuracy, stability, and user adaptability of RPA scenarios. Application fields include personalized UI automation, educational support AI, medical image diagnosis support, and user state-adaptive RPA scenario generation. These processes differ from subjective human judgment and manual criteria adjustment, realizing multivariate data analysis and autonomous matching criteria control by computer, and bringing about evolution and improvement of image matching technology itself.

The correction unit can estimate a user's emotion and adjust the correction method based on the estimated emotion of the user. For example, when the user is focused, strict correction methods can be applied. When the user is fatigued, simple correction methods can be applied. Furthermore, when the user is relaxed, correction methods tailored to the user's pace can be applied. By adjusting the correction method based on the user's emotion, the correction unit enables efficient correction. Specifically, the correction unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The correction unit preprocesses these data to generate face feature vectors (e.g., 68 facial landmarks), audio emotion features (e.g., MFCC, pitch), and operation pattern vectors (e.g., 10 dimensions). A generative AI model (e.g., Transformer-based multimodal model) inputs these feature vectors and outputs emotion labels (e.g., “focused”, “fatigued”, “relaxed”) and emotion scores (e.g., focused 0.85, fatigued 0.10, relaxed 0.05). Examples of AI model output include: input: face image+click frequency→output: emotion “focused”, score 0.92; or input: audio+heart rate→output: emotion “fatigued”, score 0.80. According to the estimated emotion, the correction unit dynamically changes the selection of correction algorithms and parameter settings. For example, in the “focused” state, high-precision correction such as time-series correction using Kalman filter or subpixel interpolation is applied, and thresholds for position offset and color correction coefficients are strictly set. In the “fatigued” state, simple corrections with low computational load such as median correction or histogram equalization are selected to reduce user load. In the “relaxed” state, individually optimized correction parameters are applied based on the user's past correction history and operation tendencies. Examples of AI model input/output include: input: bounding box (x=120, y=80, w=40, h=20)+emotion “focused”→output: corrected bounding box (x=121, y=81, w=40, h=20); or input: color-shifted image+emotion “fatigued”→output: simply color-corrected image. As a subsequent process, the correction unit passes the corrected position information and image data to the automatic execution module of the RPA scenario, and if the confidence is below the threshold, instructs re-correction or additional data collection. As a technical effect, the correction unit greatly improves correction accuracy, computational efficiency, and user adaptability through dynamic correction method control according to the user's state. Application fields include personalized UI automation, educational support AI, medical image diagnosis support, and user state-adaptive RPA scenario generation. These processes differ from subjective human judgment and manual correction method selection, realizing multivariate data analysis and autonomous correction control by computer, and bringing about evolution and improvement of image correction technology itself.

The preprocessing unit can estimate a user's emotion and adjust the preprocessing method based on the estimated emotion of the user. For example, when the user is focused, strict preprocessing methods can be applied. When the user is fatigued, simple preprocessing methods can be applied. Furthermore, when the user is relaxed, preprocessing methods tailored to the user's pace can be applied. By adjusting the preprocessing method based on the user's emotion, the preprocessing unit enables efficient preprocessing. Specifically, the preprocessing unit receives as input various time-series data such as the user's facial expression image (e.g., face image tensor 128×128 pixels), audio waveform data (e.g., 1 second of 16 kHz samples), operation logs (e.g., click frequency, mouse movement speed), and biometric sensor data (e.g., heart rate, skin conductance). The preprocessing unit preprocesses these data to generate face feature vectors (e.g., 68 facial landmarks), audio emotion features (e.g., MFCC, pitch), and operation pattern vectors (e.g., 10 dimensions). A generative AI model (e.g., Transformer-based multimodal model) inputs these feature vectors and outputs emotion labels (e.g., “focused”, “fatigued”, “relaxed”) and emotion scores (e.g., focused 0.85, fatigued 0.10, relaxed 0.05). Examples of AI model output include: input: face image+click frequency→output: emotion “focused”, score 0.92; or input: audio+heart rate→output: emotion “fatigued”, score 0.80. According to the estimated emotion, the preprocessing unit dynamically changes the selection of preprocessing algorithms and parameter settings. For example, in the “focused” state, high-precision preprocessing such as noise removal, contrast correction, and normalization is applied, and thresholds and filter sizes are strictly set. In the “fatigued” state, simple preprocessing with low computational load (e.g., resizing only, simple histogram equalization) is selected to reduce user load. In the “relaxed” state, individually optimized preprocessing parameters are applied based on the user's past preprocessing history and operation tendencies. Examples of AI model input/output include: input: image tensor+emotion “focused”→output: noise removal strength 0.9, contrast correction coefficient 1.2; or input: image tensor+emotion “fatigued”→output: apply resizing only. As a subsequent process, the preprocessing unit passes the preprocessed image data to the learning unit and matching unit, and if the confidence is below the threshold, instructs re-preprocessing or additional data collection. As a technical effect, the preprocessing unit greatly improves preprocessing accuracy, computational efficiency, and user adaptability through dynamic preprocessing method control according to the user's state. Application fields include personalized UI automation, educational support AI, medical image diagnosis support, and user state-adaptive RPA scenario generation. These processes differ from subjective human judgment and manual preprocessing method selection, realizing multivariate data analysis and autonomous preprocessing control by computer, and bringing about evolution and improvement of image preprocessing technology itself.

Below is a brief description of the processing flow of Example of the Embodiment. Specifically, the system collects diverse data such as user operations, geographic information, and social media activity via the collection unit; performs quality evaluation, noise removal, and device integration via the preprocessing unit; conducts emotion estimation, data selection, and algorithm optimization via the learning unit; performs multidimensional feature analysis, dynamic criteria control, and geographic distribution consideration via the matching unit; applies history reference, parameter optimization, and environment-adaptive correction via the correction unit; and executes resource allocation, priority control, and heterogeneous device integration via the hardware management unit, with each module operating in coordination. Each module utilizes AI models (e.g., CNN, RNN, Transformer, meta-learning networks) to autonomously perform feature extraction, scoring, parameter optimization, history analysis, and resource control on input data. Examples of AI model input/output include: collection unit: operation history vector→collection priority list; preprocessing unit: image tensor→quality score; learning unit: emotion feature vector→learning data selection; matching unit: image feature vector →matching score; correction unit: correction history→optimal parameters; hardware management unit: resource status→allocation instructions. As a subsequent process, each module passes output results to the next module, realizing a highly accurate, efficient, and adaptive AI system as a whole. As a technical effect, the system, unlike conventional static and single-function systems, realizes multivariate data analysis, autonomous control, and continuous optimization by computer, and brings about evolution and improvement of AI application platform technology itself.

Step 1: The collection unit collects image data of target objects. For example, the collection unit can collect screenshots of buttons and icons at multiple angles and resolutions. The collection unit can collect image data at various angles and resolutions, such as 30°, 60°, 720 p, 1080 p, etc. Step 2: The learning unit analyzes the collected image data and learns patterns for recognizing specific objects. For example, the learning unit can learn image data using algorithms such as deep learning or support vector machines. The learning unit can learn specific patterns such as shape, color, and texture. Step 3: The matching unit performs image matching using an AI model learned by the learning unit. For example, the matching unit can perform image matching using methods such as feature point matching or template matching. The matching unit can recognize objects on a screen and specifically identify their positions. Step 4: The correction unit performs correction based on the position of an object recognized by the matching unit. For example, the correction unit can perform correction using methods such as position correction or color correction. As a result, the RPA scenario creation system according to the embodiment can improve the accuracy of image matching and execute RPA scenarios more stably and accurately. Some or all of the above-described processes in the correction unit may be performed using AI or without using AI. For example, the correction unit can perform correction using an AI model that performs correction based on the position of the recognized object. Specifically, in Step 1, the collection unit automatically detects buttons and icons on the user interface and acquires images at specified angles (e.g., 0°, 30°, 60°, 90°) and resolutions (e.g., 720 p, 1080 p, 4K) using a screen capture API. The collection unit applies rotation matrices and resizing algorithms during image acquisition to generate images of the same object from various perspectives and scales. In Step 2, the learning unit selects different architectures such as convolutional neural networks (CNN), Vision Transformer, and support vector machines (SVM), inputs image tensors (e.g., 3-channel RGB, 224×224 pixels), and extracts low-dimensional features such as edges, corners, color distribution, and texture patterns in the feature extraction layer. The learning unit generates high-dimensional feature vectors (e.g., 512 dimensions) in the intermediate layer and outputs object class labels and bounding box coordinates in the fully connected and classification layers. During learning, weights are optimized by backpropagation using cross-entropy loss and IoU loss. In Step 3, the matching unit uses the trained AI model to calculate cosine similarity or Euclidean distance between feature vectors of input images and template images, and determines a match if the threshold (e.g., 0.85 or higher) is exceeded. Matching results include detected object positions (e.g., x, y, w, h in screen coordinates) and confidence scores (e.g., 0.92). In Step 4, the correction unit receives these output values, refers to past matching error history and screen layout information, and applies position correction algorithms (e.g., time-series correction using Kalman filter, local subpixel interpolation). Examples of AI model input/output include: input: button image of 224×224 pixels→output: bounding box (x=120, y=80, w=40, h=20), confidence 0.95; or input: icon image of different resolution→output: multiple candidate positions and scores (e.g., candidate 1: x=50, y=60, 0.88; candidate 2: x=52, y=62, 0.85). As a subsequent process, the correction unit instructs re-matching or additional data collection if the confidence is below the threshold, and passes accurate position information to the automatic execution module of the RPA scenario if the confidence is above the threshold. As a technical effect, the system, unlike conventional simple template matching or manual position specification, realizes robust object recognition and correction resistant to environmental changes such as lighting variation, resolution differences, and screen layout changes by combining similarity calculation in high-dimensional feature space and time-series correction, greatly improving the automation accuracy, stability, and reproducibility of RPA scenarios. Application fields include automatic operation of business applications, test automation, automation tools robust to UI changes, image-based automatic control in manufacturing sites, and automatic labeling of medical images. These configurations and processing procedures are not mere automation of human tasks, but bring about evolution and improvement of computer-based image recognition and correction technology itself.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned collection unit, learning unit, matching unit, and correction unit is implemented by at least one of, for example, the smart device 14 and the data processing apparatus 12. For example, the collection unit collects image data of a target object using the camera 42 of the smart device 14. The learning unit analyzes the image data collected by the specific processing unit 290 of the data processing apparatus 12 and learns patterns for recognizing specific objects. The matching unit performs image matching using the AI model learned by the learning unit, recognizes objects on the screen, and identifies their positions. The correction unit performs correction based on the position of the object recognized by the matching unit and identifies the accurate position. The correspondence between each unit and the device or control unit is not limited to the examples described above and various modifications are possible.

### Second Embodiment

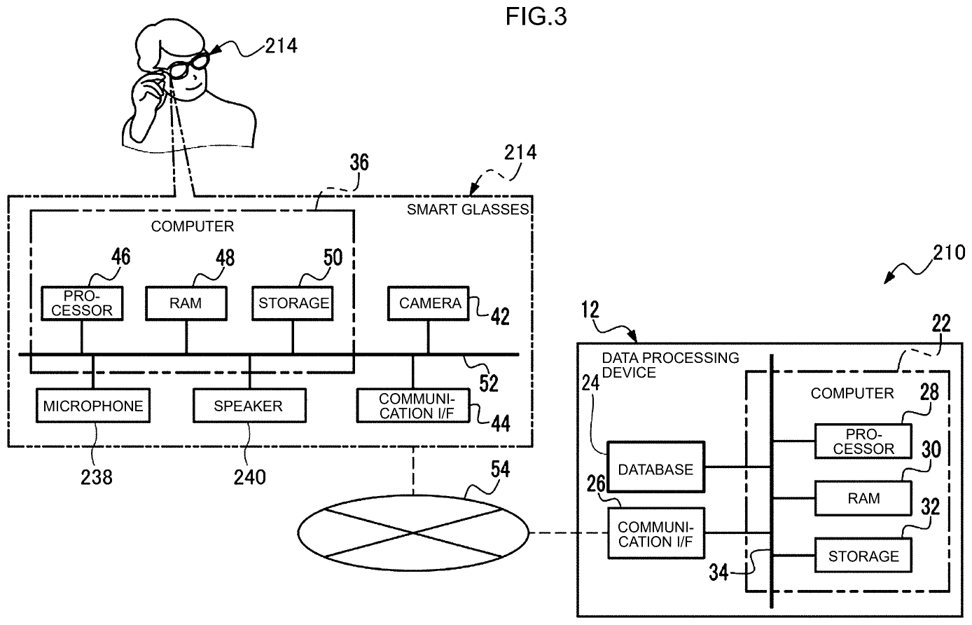

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

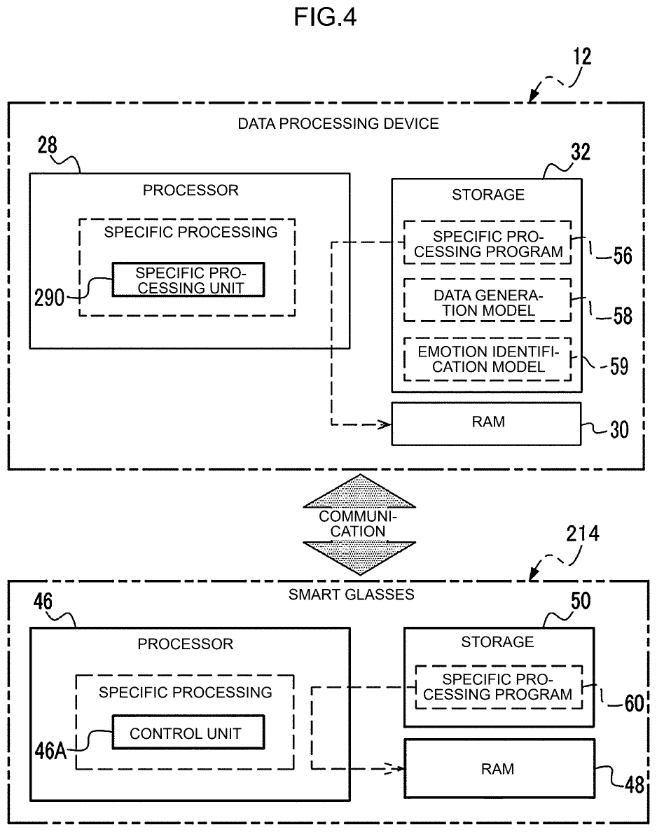

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned collection unit, learning unit, matching unit, and correction unit is implemented by at least one of, for example, the smart glasses 214 and the data processing apparatus 12. For example, the collection unit collects image data of a target object using the camera 42 of the smart glasses 214. The learning unit analyzes the image data collected by the specific processing unit 290 of the data processing apparatus 12 and learns patterns for recognizing specific objects. The matching unit performs image matching using the AI model learned by the learning unit, recognizes objects on the screen, and identifies their positions. The correction unit performs correction based on the position of the object recognized by the matching unit and identifies the accurate position. The correspondence between each unit and the device or control unit is not limited to the examples described above and various modifications are possible.

### Third Embodiment

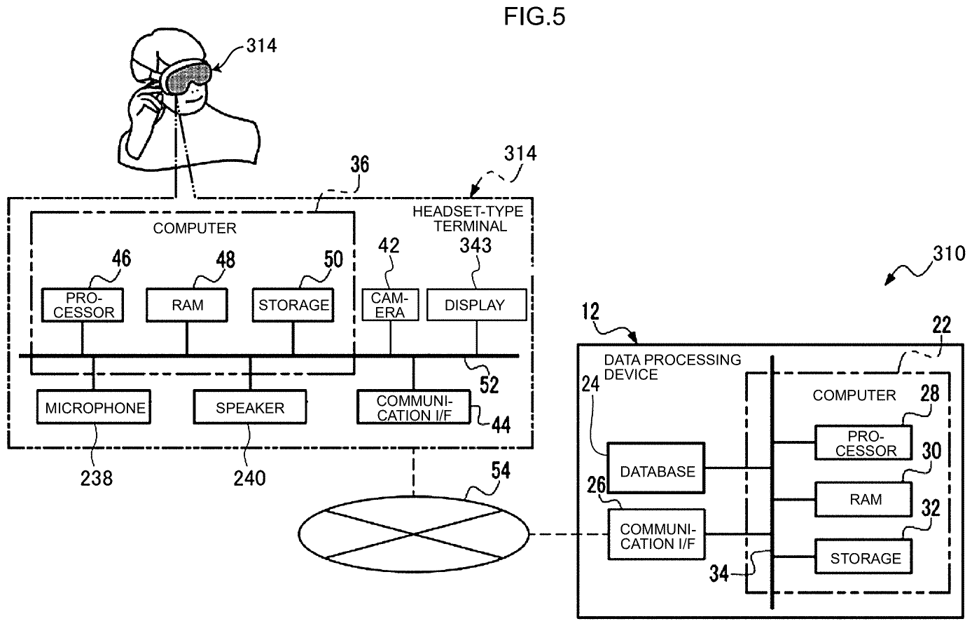

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

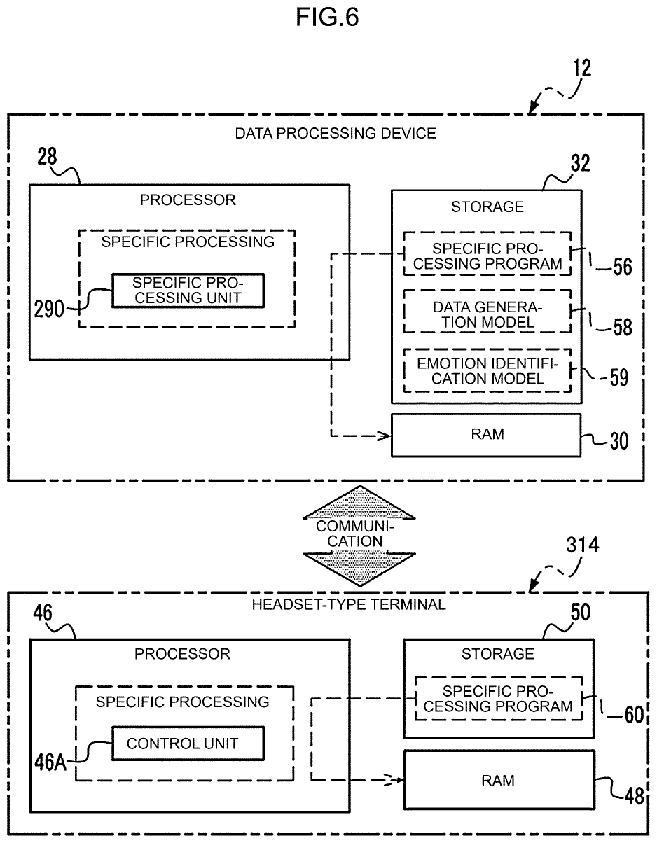

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned collection unit, learning unit, matching unit, and correction unit is implemented by at least one of, for example, the headset-type terminal 314 and the data processing apparatus 12. For example, the collection unit collects image data of a target object using the camera 42 of the headset-type terminal 314. The learning unit analyzes the image data collected by the specific processing unit 290 of the data processing apparatus 12 and learns patterns for recognizing specific objects. The matching unit performs image matching using the AI model learned by the learning unit, recognizes objects on the screen, and identifies their positions. The correction unit performs correction based on the position of the object recognized by the matching unit and identifies the accurate position. The correspondence between each unit and the device or control unit is not limited to the examples described above and various modifications are possible.

### Fourth Embodiment

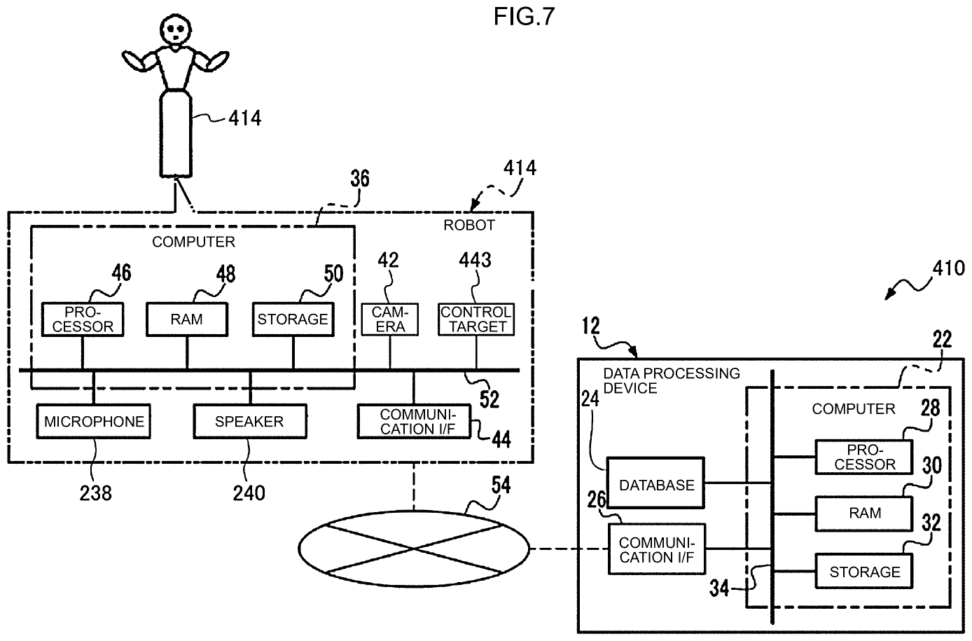

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

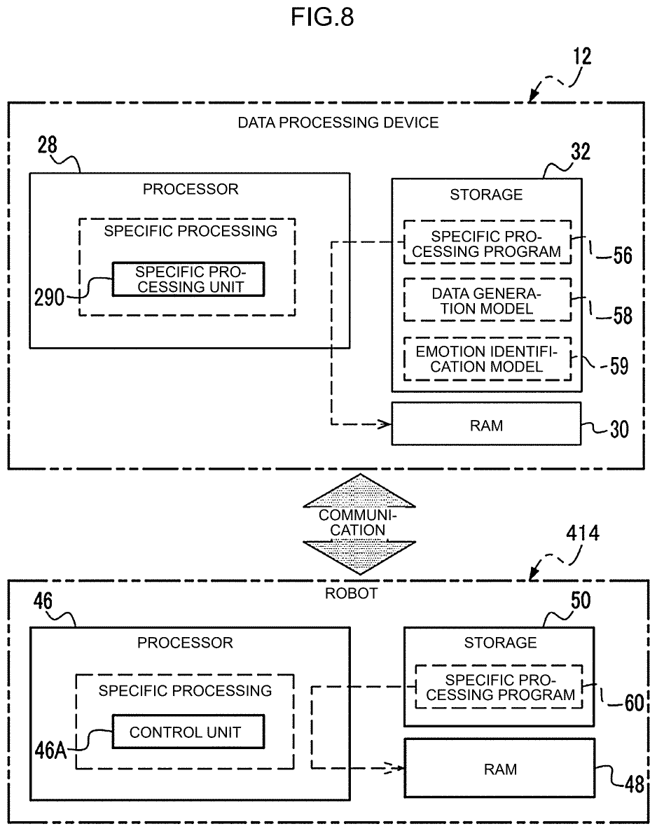

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned collection unit, learning unit, matching unit, and correction unit is implemented by at least one of, for example, the robot 414 and the data processing apparatus 12. For example, the collection unit collects image data of a target object using the camera 42 of the robot 414. The learning unit analyzes the image data collected by the specific processing unit 290 of the data processing apparatus 12 and learns patterns for recognizing specific objects. The matching unit performs image matching using the AI model learned by the learning unit, recognizes objects on the screen, and identifies their positions. The correction unit performs correction based on the position of the object recognized by the matching unit and identifies the accurate position. The correspondence between each unit and the device or control unit is not limited to the examples described above and various modifications are possible.

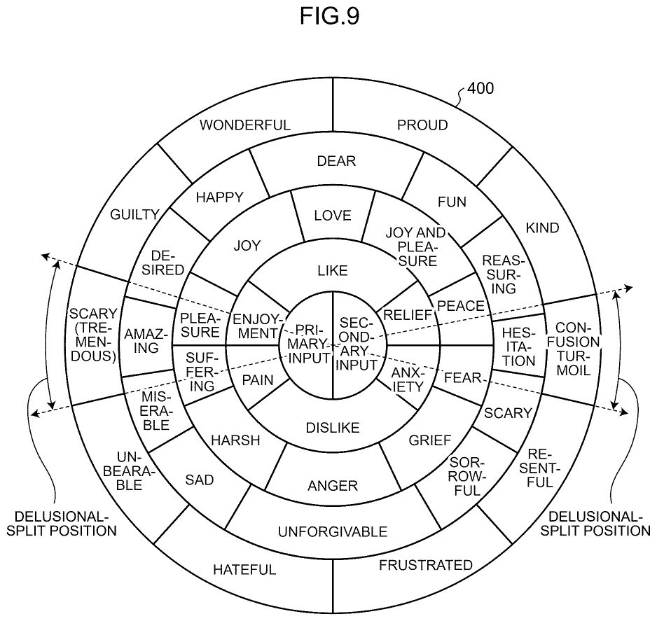

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

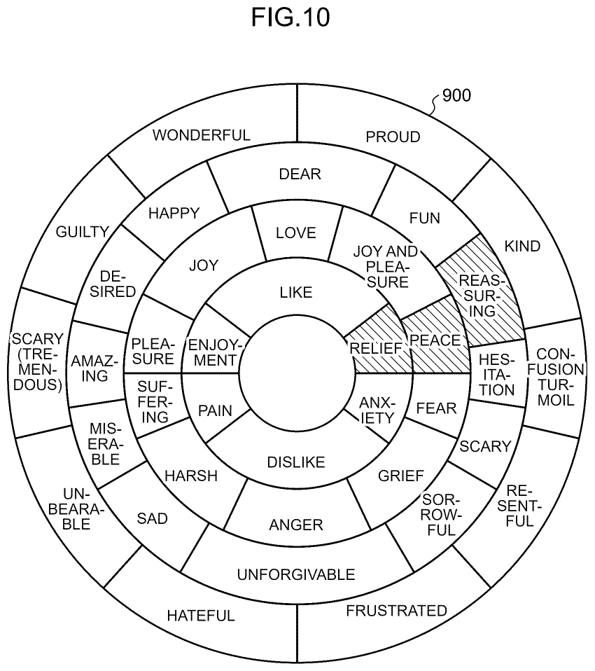

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### Supplementary Note 1

A system comprising: a collection unit configured to collect image data; a learning unit configured to learn the image data collected by the collection unit; a matching unit configured to perform image matching using an AI model learned by the learning unit; and a correction unit configured to correct the position of an object recognized by the matching unit.

### Supplementary Note 2

The system according to Supplementary Note 1, further comprising a preprocessing unit configured to perform preprocessing of learning data.

### Supplementary Note 3

The system according to Supplementary Note 1, further comprising a hardware management unit configured to manage hardware used for learning.

### Supplementary Note 4

The system according to Supplementary Note 1, wherein the collection unit is configured to collect screenshots of buttons and icons at various angles and resolutions.

### Supplementary Note 5

The system according to Supplementary Note 1, wherein the learning unit is configured to analyze the collected image data and learn specific patterns for recognizing particular objects.

### Supplementary Note 6

The system according to Supplementary Note 1, wherein the matching unit is configured to recognize objects on a screen and specifically identify their positions.

### Supplementary Note 7

The system according to Supplementary Note 1, wherein the correction unit is configured to perform correction based on the position of the recognized object.

### Supplementary Note 8

The system according to Supplementary Note 1, wherein the collection unit is configured to estimate a user's emotion and adjust the timing of image data collection based on the estimated emotion of the user.

### Supplementary Note 9

The system according to Supplementary Note 1, wherein the collection unit is configured to dynamically change the types of image data to be collected based on the user's operation history.

### Supplementary Note 10

The system according to Supplementary Note 1, wherein the collection unit is configured to evaluate the quality of image data in real time during collection and automatically exclude data determined to be of low quality.

### Supplementary Note 11

The system according to Supplementary Note 1, wherein the collection unit is configured to estimate a user's emotion and determine the priority of image data to be collected based on the estimated emotion of the user.

### Supplementary Note 12

The system according to Supplementary Note 1, wherein the collection unit is configured to preferentially collect highly relevant image data based on the user's geographic location information during collection.

### Supplementary Note 13

The system according to Supplementary Note 1, wherein the collection unit is configured to analyze the user's social media activity and collect related image data during collection.

### Supplementary Note 14

The system according to Supplementary Note 1, wherein the learning unit is configured to estimate a user's emotion and select learning data based on the estimated emotion of the user.

### Supplementary Note 15

The system according to Supplementary Note 1, wherein the learning unit is configured to optimize a learning algorithm by referring to past learning data during learning.

### Supplementary Note 16

The system according to Supplementary Note 1, wherein the learning unit is configured to improve the versatility of the model by combining image data of different resolutions and angles during learning.

### Supplementary Note 17

The system according to Supplementary Note 1, wherein the learning unit is configured to estimate a user's emotion and adjust the frequency of learning based on the estimated emotion of the user.

### Supplementary Note 18

The system according to Supplementary Note 1, wherein the learning unit is configured to weight learning data based on the timing of image data collection during learning.

### Supplementary Note 19

The system according to Supplementary Note 1, wherein the learning unit is configured to integrate image data collected from different devices during learning.

### Supplementary Note 20

The system according to Supplementary Note 1, wherein the matching unit is configured to estimate a user's emotion and adjust matching criteria based on the estimated emotion of the user.

### Supplementary Note 21

The system according to Supplementary Note 1, wherein the matching unit is configured to improve matching accuracy by specifically considering interrelationships among image data during matching.

### Supplementary Note 22

The system according to Supplementary Note 1, wherein the matching unit is configured to perform matching by combining image data of different resolutions and angles during matching.

### Supplementary Note 23

The system according to Supplementary Note 1, wherein the matching unit is configured to estimate a user's emotion and adjust the order in which matching results are displayed based on the estimated emotion of the user.

### Supplementary Note 24

The system according to Supplementary Note 1, wherein the matching unit is configured to perform matching by specifically considering the geographic distribution of image data during matching.

### Supplementary Note 25

The system according to Supplementary Note 1, wherein the matching unit is configured to improve matching accuracy by referring to related literature during matching.

### Supplementary Note 26

The system according to Supplementary Note 1, wherein the correction unit is configured to estimate a user's emotion and adjust the correction method based on the estimated emotion of the user.

### Supplementary Note 27

The system according to Supplementary Note 1, wherein the correction unit is configured to select a specific correction method by referring to past correction history during correction.

### Supplementary Note 28

The system according to Supplementary Note 1, wherein the correction unit is configured to perform correction by combining image data of different resolutions and angles during correction.

### Supplementary Note 29

The system according to Supplementary Note 1, wherein the correction unit is configured to estimate a user's emotion and determine the priority of correction based on the estimated emotion of the user.

### Supplementary Note 30

The system according to Supplementary Note 1, wherein the correction unit is configured to perform correction by considering the geographic distribution of image data during correction.

### Supplementary Note 31

The system according to Supplementary Note 1, wherein the correction unit is configured to improve correction accuracy by referring to specific related literature during correction.

### Supplementary Note 32

The system according to Supplementary Note 2, wherein the preprocessing unit is configured to estimate a user's emotion and adjust the preprocessing method based on the estimated emotion of the user.

### Supplementary Note 33

The system according to Supplementary Note 2, wherein the preprocessing unit is configured to evaluate the quality of image data during preprocessing and automatically exclude data of low quality.

### Supplementary Note 34

The system according to Supplementary Note 2, wherein the preprocessing unit is configured to estimate a user's emotion and determine the priority of preprocessing based on the estimated emotion of the user.

### Supplementary Note 35

The system according to Supplementary Note 2, wherein the preprocessing unit is configured to integrate image data collected from different devices during preprocessing.

### Supplementary Note 36

The system according to Supplementary Note 3, wherein the hardware management unit is configured to estimate a user's emotion and adjust hardware usage based on the estimated emotion of the user.

### Supplementary Note 37

The system according to Supplementary Note 3, wherein the hardware management unit is configured to select an optimal hardware configuration by referring to past usage history during hardware management.

### Supplementary Note 38

The system according to Supplementary Note 3, wherein the hardware management unit is configured to estimate a user's emotion and determine the priority of hardware based on the estimated emotion of the user.

### Supplementary Note 39

The system according to Supplementary Note 3, wherein the hardware management unit is configured to integrate usage status of different devices during hardware management.

What is claimed is:

1. A system comprising:
a communication interface configured to communicate with a client terminal via a network;
a storage storing a data generation model obtained by deep learning on a neural network;
circuitry configured to:
collect, via the communication interface, image data of a target object from the client terminal, the image data comprising screenshots captured at a plurality of angles and a plurality of resolutions;
train an artificial intelligence model by extracting feature vectors from the image data using a convolutional neural network and optimizing weights by backpropagation using cross-entropy loss;
perform image matching by calculating a similarity between the feature vectors extracted from an input image and feature vectors of a template image using the trained artificial intelligence model, and determine a match when the similarity exceeds a threshold; and
correct a position of the target object recognized by the image matching based on a matching error history by applying a position correction algorithm to output corrected position coordinates of the target object, and transmit the corrected position coordinates to the client terminal via the communication interface.

2. The system according to claim 1,
wherein the circuitry is further configured to perform preprocessing of the image data prior to training, the preprocessing comprising at least one of noise removal, normalization, or contrast correction.

3. The system according to claim 1,
further comprising a hardware management circuitry configured to monitor a usage status of hardware resources in real time and dynamically adjust allocation of the hardware resources used for training the artificial intelligence model.

4. The system according to claim 1,
wherein the image data comprises screenshots of buttons and icons captured at angles comprising 0°, 30°, 60°, and 90°, and at resolutions comprising 720 p, 1080 p, and 4K.

5. The system according to claim 1,
wherein the circuitry is configured to extract, using the convolutional neural network, feature vectors of at least 512 dimensions from image tensors of the image data, and to output classification labels and bounding box coordinates comprising a top-left x coordinate, a y coordinate, a width, and a height.

6. The system according to claim 1,
wherein the circuitry is configured to determine the match by calculating at least one of a cosine similarity or a Euclidean distance between the feature vectors, and to output detected object positions in screen coordinates and confidence scores.

7. The system according to claim 1,
wherein the position correction algorithm comprises at least one of a Kalman filter for time-series correction or a subpixel interpolation algorithm.

8. The system according to claim 1,
wherein the circuitry is further configured to estimate an emotion of a user by inputting at least one of a facial expression image, audio waveform data, or biometric sensor data into an emotion estimation model, and to adjust a timing of collecting the image data based on the estimated emotion.

9. The system according to claim 1,
wherein the circuitry is further configured to analyze an operation history of a user comprising click events and button identifiers, and to dynamically change types of the image data to be collected by prioritizing image data of frequently operated objects based on the operation history.

10. The system according to claim 1,
wherein the circuitry is further configured to evaluate a quality of the image data in real time during collection by applying at least one of a resolution determination algorithm, a brightness evaluation algorithm, or a noise level estimation algorithm, and to automatically exclude image data having a quality score below a predetermined threshold.

11. The system according to claim 1,
wherein the circuitry is further configured to estimate an emotion of a user and to select training data for the artificial intelligence model based on the estimated emotion, wherein high-difficulty image data is selected when the estimated emotion indicates a focused state and simple image data is selected when the estimated emotion indicates a fatigued state.

12. The system according to claim 1,
wherein the circuitry is further configured to improve versatility of the artificial intelligence model by combining image data of different resolutions and different angles during training, and applying at least one of mini-batch normalization or domain adaptation to the combined image data.

13. The system according to claim 1,
wherein the circuitry is further configured to estimate an emotion of a user and to dynamically adjust the threshold for the image matching based on the estimated emotion, wherein a stricter threshold is applied when the estimated emotion indicates a focused state and a relaxed threshold is applied when the estimated emotion indicates a fatigued state.

14. The system according to claim 1,
wherein the circuitry is further configured to select the position correction algorithm by referring to a past correction history comprising bounding box coordinates before and after correction, correction algorithm type, and correction error values, and to automatically update correction parameters based on the past correction history.

15. The system according to claim 1,
wherein the circuitry is further configured to perform the correction by combining image data of different resolutions and different angles, and to extract feature vectors for the different resolutions and the different angles using a multi-scale correction network to output optimal correction parameters.

16. The system according to claim 1,
wherein the circuitry is further configured to receive geographic location information comprising GPS coordinates from the client terminal, and to preferentially collect image data of objects associated with a geographic region indicated by the GPS coordinates.

17. The system according to claim 1,
wherein the circuitry is further configured to instruct re-matching or additional data collection when a confidence score of the image matching is below the threshold, and to transmit the corrected position coordinates to an automatic execution module of a robotic process automation scenario when the confidence score is above the threshold.

18. A system comprising:
a communication interface configured to communicate with a client terminal via a network, the communication interface supporting at least one of 5G, Wi-Fi, or Bluetooth;
a processor;
a RAM connected to the processor via a bus;
a storage storing a data generation model obtained by deep learning on a neural network, an emotion identification model, and a specific processing program;
a database connected to the bus; and
circuitry realized by the processor executing the specific processing program on the RAM, the circuitry configured to:
collect, via the communication interface, image data of a target object from the client terminal, the image data comprising screenshots of buttons and icons captured at angles comprising 0°, 30°, 60°, and 90°, and at resolutions comprising 720 p, 1080 p, and 4K;
preprocess the image data by applying at least one of noise removal using a Gaussian filter, normalization by scaling pixel values to a range of 0 to 1, or contrast correction;
train an artificial intelligence model by extracting feature vectors of at least 512 dimensions from image tensors using a convolutional neural network, and optimizing weights by backpropagation using cross-entropy loss and intersection over union loss;
perform image matching by calculating at least one of a cosine similarity or a Euclidean distance between the feature vectors extracted from an input image and feature vectors of a template image, and determine a match when the similarity exceeds a threshold to output detected object positions in screen coordinates and confidence scores;
correct a position of the target object by applying at least one of a Kalman filter for time-series correction or a subpixel interpolation algorithm while referring to a past matching error history, to output corrected position coordinates; and
transmit the corrected position coordinates to the client terminal via the communication interface.

19. The system according to claim 18,
wherein the circuitry is further configured to estimate an emotion of a user using the emotion identification model by inputting at least one of a facial expression image, audio waveform data, an operation log, or biometric sensor data, and to dynamically adjust the threshold for the image matching and a selection of the position correction algorithm based on the estimated emotion.

20. A method performed by a system comprising a communication interface, a storage, and circuitry, the method comprising:
collecting, via the communication interface, image data of a target object from a client terminal communicating with the system via a network, the image data comprising screenshots captured at a plurality of angles and a plurality of resolutions;
training an artificial intelligence model by extracting feature vectors from the image data using a convolutional neural network and optimizing weights by backpropagation using cross-entropy loss;
performing image matching by calculating a similarity between the feature vectors extracted from an input image and feature vectors of a template image using the trained artificial intelligence model, and determining a match when the similarity exceeds a threshold; and
correcting a position of the target object recognized by the image matching based on a matching error history by applying a position correction algorithm to output corrected position coordinates of the target object, and transmitting the corrected position coordinates to the client terminal via the communication interface.
